(19) United States
(12) Patent Application Publication
(10) Pub. No.: US 2019/0284447 A1
(43) Pub. Date: Sep. 19, 2019

(54) Pressure-Sensitive Adhesive Sheet and Use Thereof

(71) Applicant: Nitto Denko Corporation, Osaka (JP)

(72) Inventors: Kenji FURUTA, Osaka (JP); Akira HIRAO, Osaka (JP); Tatsuya SUZUKI, Osaka (JP); Hiroki IEDA, Osaka (JP)

(21) Appl. No.: 16/355,898

(22) Filed: Mar. 18, 2019

(30) Foreign Application Priority Data
Mar. 19, 2018 (JP) 2018-051400

(51) Int. Cl. C09J 7/38; G11B 25/04; C09J 7/40; C09J 109/00; C09J 133/10

(52) U.S. Cl. CPC C09J 7/385; G11B 25/043; C09J 7/401; C09J 7/383; C09J 2483/005; C09J 133/10; C09J 2203/326; C09J 2423/006; C09J 2467/006; C09J 109/00

(57) ABSTRACT

Provided is a PSA sheet for use in electronic devices suitable for their downsizing and densification. The PSA sheet for electronic devices provided by this invention comprises a substrate and a PSA layer provided to at least one face of the substrate. The PSA sheet has a laser absorbance of 20% or higher in a wavelength range of 1000 nm to 1100 nm; has a thermal shrinkage S_{MD} in its machine direction and a thermal shrinkage S_{TD} in its transverse direction (direction perpendicular to the machine direction) of both −2 % or greater and 2% or less; and has an amount of thermally released gas of 1300 ng/cm² or less when determined at 80° C. for 3 hours by GC/MS.

### CROSS-REFERENCE

The present invention claims priority to Japanese Patent Application No. 2018-051400 filed on Mar. 19, 2018 and the entire content thereof is incorporated herein by reference.

### BACKGROUND OF THE INVENTION

### 1. Field of the Invention

The present invention is related to a pressure-sensitive adhesive sheet, a release-lined pressure-sensitive adhesive sheet, and a magnetic disc device comprising a pressure-sensitive adhesive sheet.

### 2. Description of the Related Art

In general, pressure-sensitive adhesive (PSA) exists as a soft solid (a viscoelastic material) in a room temperature range and has a property to adhere easily to an adherend with some pressure applied. For such a property, PSA is widely used in various industrial fields in a form of for instance, an on-substrate PSA sheet having a PSA layer on a support substrate. Substrate-supported PSA sheets can be preferably used in manufacturing of electronic devices as well. For instance, Japanese Patent Application Publication No. 2000-248237 is a technical document related to a PSA sheet used in assembling a hard disc device which is a type of electronic device. Japanese Patent Application Publication No. 2009-74060 is also a technical document related to a double-faced PSA sheet for fastening hard disc drive components.

### SUMMARY OF THE INVENTION

In general, PSA sheets for use in electronic devices are processed (machined) prior to use (i.e. before applied to adherends) so that they have desirable shapes according to their purposes. As the method for processing a PSA sheet into a desired shape, die cutting with a Thomson blade or a pinnacle blade is widely used. During manufacturing of an electronic device, the desirably-shaped PSA sheet is placed and applied in a prescribed area of adherend (typically a component of the electronic device).

Lately, in association with recent downsizing and densification of electronic devices, there are growing demands for making smaller, more complicated and precise shapes (or comprehensively “precision shaping” hereinafter) with regard to PSA sheets for electronic devices. However, because of such precision shaping, it is sometimes difficult to apply a PSA sheet to an adherend with good shape accuracy (with a precise shape match). For instance, the PSA sheet may deform under its own weight or under tensile stress caused by a force applied to peel off the release liner from the PSA layer surface (adhesive face).

The present invention has been made in view of such circumstances with an objective to provide a PSA sheet that is used in electronic devices and is suited for their downsizing and densification. Another related objective is to provide a release-lined PSA sheet (a PSA sheet with release liner) that comprises such a PSA sheet as a component. Yet another related objective is to provide an electronic device bearing the PSA sheet, in particular, a magnetic disc device.

The present description provides a PSA sheet for electronic devices, the PSA sheet comprising a substrate and a PSA layer provided to at least one face of the substrate. The PSA sheet has a laser absorbance of 20% or higher in a wavelength range of 1000 nm to 1100 nm. When heated at 130° C. for two minutes in a thermal contraction test, the PSA sheet has a thermal shrinkage in its machine direction (MD) S_{MD} and a thermal shrinkage in its transverse direction (TD, width direction (direction perpendicular to MD) S_{TD} of −2% or greater and 2% or less. The PSA sheet has an amount of thermally released gas of 1300 ng/cm² or less when determined at 80° C. for 3 hours by gas chromatography/mass spectrometry (GC-MS).

The PSA sheet thus constituted has a laser absorbance of 20% or higher in the wavelength range of 1000 nm to 1100 nm; and therefore, it can efficiently absorb laser light having a dominant wavelength in the range of 1000 nm to 1100 nm (or “specific laser (light)” hereinafter). Such a laser-absorbing PSA sheet shows excellent machinability by laser irradiation (laser machinability). Thus, it can be preferably used in an embodiment where the PSA sheet adhered on an adherend (typically a component of an electronic device) is subjected to laser machining as necessary. Once adhered on the adherend, laser machining can be provided using the adherend as a reference for alignment: and therefore, this embodiment can minimize the influence of the PSA sheet on the accuracy of its application to the adherend, thereby increasing the accuracy of position. In addition, because the PSA sheet has low thermal shrinkage, deformation by the heat of laser machining can be reduced to allow machining with good shape accuracy. For instance, low thermal shrinkage is particularly significant in an embodiment where, after the PSA sheet is applied to the adherend, laser machining is provided to an area where the adhesive face of the PSA sheet does not make contact with the adherend (not in direct contact with the adherend). With respect to the PSA sheet, the amount of thermally released gas is also greatly limited. Such a PSA sheet can be preferably used in an application for which the presence of volatile gas is undesirable. When the PSA sheet disclosed herein is used for fastening a component in manufacturing of a magnetic disc device, it can greatly limit formation of internal gas that may affect the device's normal and highly precise operation.

The PSA sheet according to a preferable embodiment has a peel distance less than 50 mm in a constant load peel test where a 30 g load is applied for one hour. Such a PSA sheet is preferable because it is likely to resist the strain that may arise from laser machining and maintain tight adhesion to the adherend.

In the PSA sheet according to a preferable embodiment, the substrate has a thickness of 30 μm or greater. Such a PSA sheet tends to show good shape stability. Thus, for instance, it can be preferably used for positioning of components in manufacturing of electronic devices.

The substrate preferably includes a resin film that comprises a laser absorber. The PSA sheet having such a substrate is likely to combine high levels of laser machinability and adhesive properties. In an embodiment, as the laser absorber, carbon black can be preferably used.

The PSA sheet according to a preferable embodiment has an amount of silicone of 20 ng/cm² or less based on polydimethylsiloxane standards and the X-ray intensity of silicon obtained by X-ray fluorescence analysis of the PSA layer surface. Hereinafter, the amount of silicone may be referred to as the “amount of silicone in adhesive face.” According to such a PSA sheet, internal contamination with siloxane gas can be greatly limited even in an application where siloxane gas is unwanted, for instance, an application where it is applied to the interior of a magnetic disc device or to an area in contact with the interior.

In the PSA sheet disclosed herein, the PSA layer can be an acrylic PSA layer comprising an acrylic polymer as the base polymer, a rubber-based PSA layer comprising a rubber-based polymer as the base polymer, or a rubber-acrylic blend PSA layer comprising a rubber-based polymer and an acrylic polymer as the base polymer. With the use of an acrylic, rubber-based, or rubber-acrylic blend PSA layer, reduction of gas release can be preferably combined with adhesive properties. In particular, an acrylic PSA layer or a rubber-based PSA layer is preferable.

As the rubber-based polymer, it is preferable to use, for instance, a polymer in which at least one species of monomer selected from the group consisting of butene, isobutylene and isoprene is polymerized. Such a rubber based polymer is suited for forming a PSA layer having excellent moisture resistance and gas-blocking properties.

In an embodiment where the PSA layer is a rubber-based PSA layer, the rubber-based PSA layer may include a rubber-based polymer A and a rubber-based polymer B as the rubber-based polymer. In the rubber-based polymer A, it is preferable that isobutylene is polymerized at a ratio of at least 50% by weight. In the rubber-based polymer B, it is preferable that isobutylene and isoprene are copolymerized. The rubber based PSA layer having such a composition is preferable since it may have excellent moisture resistance and gas-blocking properties.

This description provides a release-lined PSA sheet comprising a PSA sheet and a release liner placed directly on (placed in contact with) the PSA layer. The release liner has an amount of silicone of 20 ng/cm² or less based on polydimethylsiloxane standards and the X-ray intensity of silicon obtained by X-ray fluorescence analysis of the PSA layer side surface. Hereinafter, the amount of silicone may be referred to as the “amount of silicone in release face.” The release liner with 20 ng/cm² or less silicone in release face is less likely to cause the transfer of silicone from the release face to the adhesive face. Thus, the release-lined PSA sheet including such a release liner is also suited for an application where siloxane gas is unwanted, for instance, an application where the PSA sheet is applied to the interior of a magnetic disc device or to an area in contact with the interior. As the PSA sheet, a PSA sheet disclosed herein can be preferably used. This can favorably bring about both laser machinability of the PSA sheet and reduction of siloxane gas released from the PSA sheet.

The PSA sheet disclosed herein can be preferably used in an embodiment where it is applied to a component of an electronic device. For instance, in a favorable application, the PSA sheet is applied to the interior of a housing of an electronic device or to an area facing the interior. A favorable example of the electronic device is a magnetic disc device. Thus, this description provides a magnetic disc device comprising a PSA sheet disclosed herein. The PSA sheet may have a through hole formed by laser machining. Such a through hole may have excellent shape accuracy and position accuracy; and therefore, it can be preferably used to control the position and orientation of a component.

### BRIEF DESCRIPTION OF THE DRAWINGS

FIG. 1 shows a cross-sectional diagram schematically illustrating the PSA sheet according to an embodiment.

FIG. 2 shows a cross-sectional diagram schematically illustrating the release-lined PSA sheet according to an embodiment.

FIG. 3 shows a cross-sectional diagram schematically illustrating the PSA sheet according to another embodiment.

FIG. 4 shows a perspective diagram schematically illustrating the constitution of the magnetic disc device according to an embodiment.

FIG. 5 shows a diagram illustrating an example of application of the PSA sheet according to an embodiment.

### DETAILED DESCRIPTION OF THE INVENTION

Preferable embodiments of the present invention are described below. Matters necessary to practice this invention other than those specifically referred to in this description can be understood by a person skilled in the art based on the disclosure about implementing the invention in this description and common technical knowledge at the time the application was filed. The present invention can be practiced based on the contents disclosed in this description and common technical knowledge in the subject field. In the drawings referenced below, a common reference numeral may be assigned to members or sites producing the same effects, and redundant descriptions are sometimes omitted or simplified. The embodiments described in the drawings are schematized for clear illustration of the present invention, and do not necessarily represent the accurate size or reduction scale of a PSA sheet or magnetic disc device provided as an actual product.

As used herein, the term “PSA” refers to, as described earlier, a material that exists as a soft solid (a viscoelastic material) in a room temperature range and has a property to adhere easily to an adherend with some pressure applied. As defined in “Adhesion: Fundamentals and Practice” by C. A. Dahlquist (McLaren & Sons (1966), P. 143), in general, PSA referred to herein can be a material that has a property satisfying complex tensile modulus E* (1 Hz)<10⁷ dyne/cm² (typically, a material that exhibits the described characteristics at 25° C.).

The concept of PSA sheet herein may encompass so-called PSA tape, PSA labels, PSA sheets, etc. The PSA sheet disclosed herein can be in a roll or in a flat sheet. Alternatively, the PSA sheet may be processed into various shapes.

As used herein, the “laser absorbance” refers to a value determined by the equation (1) shown below from the transmittance T (%) and reflectance H (%) of a sample measured using a spectrophotometer (e.g. spectrophotometer under model name U-4100 available from Hitachi High-Technologies Corporation).

Absorbance A(%)=100(%)−T(%)−R(%) (I)

As used herein, the term “laser absorbance in the wavelength range of 1000 nm to 1100 nm” refers to the minimum laser absorbance in this particular wavelength range. In the description below, the term “laser absorbance” refers to the minimum laser absorbance as described above unless otherwise noted. As used herein, the term “laser absorber” refers to a material capable of increasing the laser absorbance when compared to a case where the same laser absorber is not used.

### <Constitution of PSA Sheet>

The PSA sheet disclosed herein has a PSA layer at least on one face of a substrate. The PSA sheet disclosed herein can be a single-faced PSA sheet (an adhesively single-faced PSA sheet) having a PSA layer only on one face of the substrate or it can be a double-faced PSA sheet (an adhesively double-faced PSA sheet) having a PSA layer on each of the two faces of the substrate. Hereinafter, the present invention is described more in detail primarily with respect to an example where the PSA sheet is a single-faced PSA sheet; however, the art disclosed herein is not limited to such an embodiment.

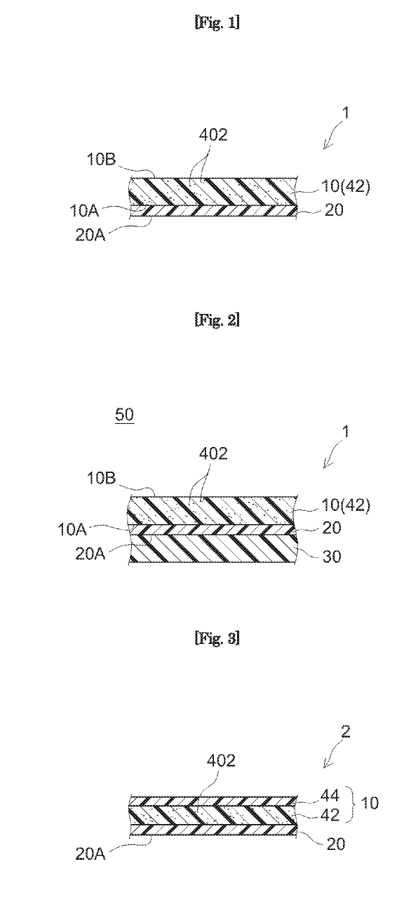

FIG. 1 schematically illustrates the constitution of the PSA sheet according to an embodiment PSA sheet 1 comprises a substrate 10 and a PSA layer 20 provided on a first face 10A thereof and PSA layer 20 is adhered to an adherend for use. In this embodiment, substrate 10 is resin film. For instance. PSA sheet 1 prior to use may be in an embodiment as shown in FIG. 2 where the surface (release face) of release liner 30 is in contact with the surface (adhesive face) 20A of PSA layer 20 to protect the adhesive face. PSA sheet 1 in such an embodiment where release face of release liner 30 is in contact with adhesive face 20A can be thought as a component of a release-lined PSA sheet 50 comprising PSA sheet 1 and release liner 30. Release-lined PSA sheet 50 can be in a form of, for instance, a flat sheet or a wound roll. When the second face 10B (opposite from the face on which the PSA layer is provided, or the “backside” hereinafter) of substrate 10 serves as a release face. PSA sheet 1 prior to use can be in a form of a wound roll or a laminate of several PSA sheet layers with backside 10B of substrate 10 in contact with adhesive face 20A.

The PSA sheet disclosed herein preferably includes at least one laser-absorbing layer that comprises a laser absorber. The laser absorber can be included in the substrate, in the PSA layer, or in both the substrate and the PSA layer. From the standpoint of making it easy to combine good laser-absorbing properties and adhesive properties, it is preferable that at least the substrate includes the laser absorber. In the PSA sheet according to some embodiments, the substrate may include a laser absorber and the PSA layer may be free of a laser absorber.

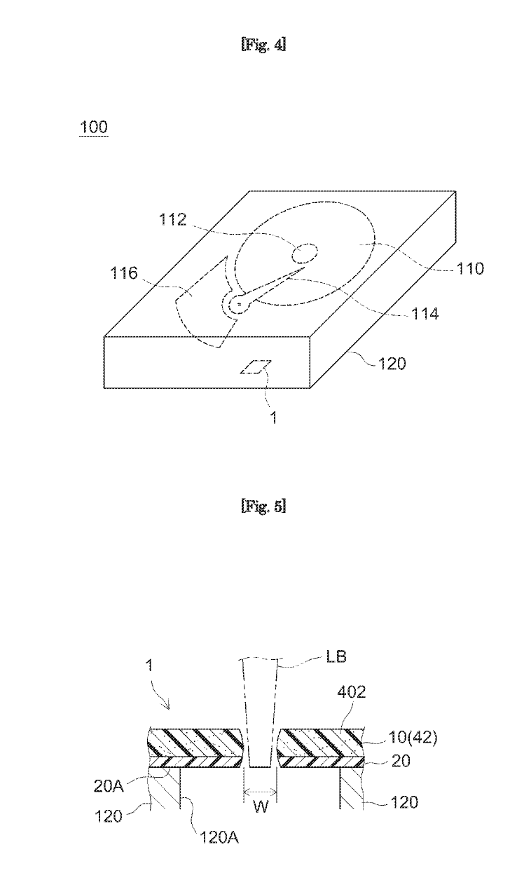

PSA sheets 1 and 2 shown in FIGS. 1 to 3 have each a laser-absorbing layer 42 that comprises a laser absorber 402 as part or whole of substrate 10. Laser-absorbing layer 42 is typically formed from a resin composition comprising laser absorber 402. In PSA sheet 1 shown in FIGS. 1 and 2, substrate 10 is resin film having a monolayer structure formed of laser-absorbing layer 42 while the structure of substrate 10 is not limited to a monolayer structure. For instance, as in PSA sheet 2 shown in FIG. 3, substrate 10 may be a laminate comprising several layers (here, the first layer 42 placed on the PSA layer 20 side and the second layer 44 placed on the backside thereof) wherein at least one may be a laser-absorbing layer 42. In the example shown in FIG. 3, the first layer 42 is a layer (a laser-absorbing layer) formed from a resin composition comprising laser absorber 402 while the second layer 44 is a layer formed from a resin composition free of a laser absorber.

### <Properties of PSA Sheet>

The PSA sheet disclosed herein is characterized by having a laser absorbance of 20% or higher in the wavelength range of 1000 nm to 1100 nm. The laser absorbance indicates the ratio of laser light actually absorbed by the PSA sheet to the specific laser light irradiated onto the PSA sheet. The PSA sheet with at least 20% laser absorbance can be heated highly efficiently by laser irradiation, showing good laser machinability. In the PSA sheet disclosed herein, only one face may satisfy the laser absorbance or each face may satisfy the laser absorbance. The PSA sheet disclosed herein can be preferably made in an embodiment of a single-faced PSA sheet where, for instance, at least the backside satisfies the laser absorbance.

In some embodiments, the laser absorbance of the PSA sheet can be, for instance, 25% or higher, 30% or higher, 45% or higher, 60% or higher, or even 75% or higher. The PSA sheet preferably includes the laser-absorbing layer in the substrate. Like the PSA sheet described above, the laser absorbance of the substrate comprising the laser-absorbing layer is preferably 20% or higher; it can be 25% or higher, 30% or higher, 45% or higher, 60% or higher, or even 75% or higher. When the substrate is formed of several layers including the laser-absorbing layer, the laser-absorbing layer preferably has a laser absorbance of 20% or higher. The laser absorbance of the laser absorbing layer can be, for instance, 25% or higher, 30% or higher, 45% or higher, 60% or higher, or even 75% or higher. The laser absorbance of the PSA sheet, the substrate or the laser-absorbing layer can be 100%; however, for practical use, it is preferably 97% or lower, 95% or lower, 90% or lower, or even 85% or lower.

The PSA sheet is not particularly limited in transmittance or reflectance. In some embodiments, in the wavelength range of 1000 nm to 1100 nm, at a wavelength of minimum laser absorbance, the PSA sheet shows a specific laser transmittance below 70%; or it can be, for instance, below 50% as well. In some embodiments, at a wavelength of minimum laser absorbance, the PSA sheet has a specific laser reflectance below 50%, for instance, below 40%, below 20%, or even below 10%. The PSA sheet satisfying at least one (preferably each) of the transmittance and the reflectance is likely to have a preferable laser absorbance disclosed herein.

When heated at 130° C. for two minutes in a thermal shrinkage test the PSA sheet disclosed herein has a thermal shrinkage S of −2% or higher and 2% or lower. More specifically a preferable PSA sheet satisfies a condition (A): having a thermal shrinkage in MD, S_{MD}, and a thermal shrinkage in TD, S_{TD}, of both −2% or higher and 2% or lower. Hereinafter, the thermal shrinkage in MD may be indicated as the “MD thermal shrinkage” and the thermal shrinkage in TD as the “TD thermal shrinkage.” The PSA sheet satisfying the condition (A) is less susceptible to thermal changes in size in both MD and TD. Thus, for instance, even if it is used in an embodiment where the PSA sheet is subjected to laser machining after applied to an adherend, deformation due to a local temperature rise during the machining is inhibited, allowing highly precise machining. This is particularly significant in an embodiment of the PSA sheet adhered on an adherend where the laser machining (typically machining such as making holes and cutouts, not reaching the periphery of the PSA sheet) is provided to an area of the PSA sheet where the adhesive face does not make contact with the adherend. In such an embodiment the PSA sheet is immobilized by the adherend in areas where the adhesive face is tightly adhered (bonded) to the adherend: and therefore, strain is likely to concentrate in the area where the adhesive face does not make contact with the adherend, thereby likely degrading the shape accuracy of the laser machined area. The area where the adhesive face does not make contact with the adherend can be, for instance, where the PSA sheet is covering an opening (possibly a through hole, a depression, etc.) in a component where the PSA sheet is placed across a gap formed between components, and where the PSA sheet extends off an edge of a component.

The thermal shrinkage is determined by the following thermal shrinkage test. In particular, a PSA sheet of interest is prepared into a 100 mm long by 100 mm wide size to obtain a measurement sample. Here, the length direction is in the PSA sheet's MD. At 25° C., the sample is measured in length in MD (length) and TD (width) to obtain the initial MD and TD lengths L₀. Subsequently, the sample is heated in an oven at 130° C. for two minutes and then removed to be left standing at 25° C. for one hour or more. The sample is measured in length in MD and TD to obtain the final MD and TD lengths (MID and TD lengths-after-heated) L₁. With respect to each of MD and TD, from the initial and final lengths L₀ and L₁, the thermal shrinkage S is determined by the equation shown below. In particular, for L₀ and L₁ in the equation below, the values in MD are substituted to determine the MD thermal shrinkage (S_{MD}). Likewise, for L₀ and L₁ in the equation below, the values in TD are substituted to determine the TD thermal shrinkage (S_{TD}). The same measurement method is employed in the working examples described later.

Thermal shrinkage S(%)=(L₀−L₁)/L₀×100

S_{MD} and S_{TD} can be adjusted through, for instance, selection of the composition, thickness, production method and the like of the substrate, the composition and thickness of the PSA layer, the preparation method of the PSA sheet, etc. It is noted that a negative thermal shrinkage value (below zero) indicates an increase in sample size as a result of the thermal shrinkage test. It can be said that the closer to zero the thermal shrinkage value is, that is, the smaller the absolute value of thermal shrinkage is, the smaller the change in size caused by the thermal shrinkage test is.

The PSA sheet disclosed herein preferably has at least |S_{MD}| or |S_{TD}| (preferably both) of 1.5% or less, more preferably 1.0% or less, yet more preferably 0.5% or less, or particularly preferably 0.3% or less or 0.2% or less. Here, |S_{MD}| is the absolute value of the MID thermal shrinkage and |S_{TD}| is the absolute value of the TD thermal shrinkage.

In some embodiments of the PSA sheet disclosed herein, S_{MD} and S_{TD} preferably satisfy the following condition (a) or (b):

S_{MD}=0% and S_{TD}=0% (a)

0%<|S_{MD}|,0%<|S_{TD}|, and 0.5≤|S_{MD}/S_{TD}|≤4 (b)

Here, |S_{MD}/S_{TD}| is the absolute value of the ratio of MD thermal shrinkage to TD thermal shrinkage (MD-to-TD thermal shrinkage ratio). Hereinafter, |S_{MD}/S_{TD}| may be referred to as the “thermal shrinkage ratio.”

The PSA sheet satisfying the condition (a) is preferable because it has excellent thermal size stability in both MD and TD.

The present inventors have discovered that with respect to the PSA sheet not satisfying the condition (a), between S_{MD}, and S_{TD}, if only one is 0%, the other thermal shrinkage tends to have a large absolute value. The reason for this should not be limited; however, it is presumed that in the PSA sheet having 0% thermal shrinkage in either MD or TD, the thermal size change tends to be highly anisotropic rather than being intrinsically small. From the standpoint of further refining the shape accuracy of laser machining, it is desirable to minimize the anisotropy of thermal size change. In the art disclosed herein, the thermal shrinkage ratio (i.e. |S_{MD}/S_{TD}|) can be used as an index to assess the degree of anisotropy of thermal shrinkage. It can be said that the closer to 1 the thermal shrinkage ratio value is, the smaller the anisotropy of thermal shrinkage is. For instance, a preferable PSA sheet has a thermal shrinkage ratio of 0.5 or higher and 4 or lower just like the condition (b). In some embodiments, the thermal shrinkage ratio can be, for instance, 3 or lower, 2 or lower, or even 1.5 or lower. For instance, the PSA sheet disclosed herein can be preferably made in an embodiment where the thermal shrinkage ratio is 0.5 or higher and 2 or lower, or 0.7 or higher and 1.5 or lower.

The PSA sheet disclosed herein has an amount of thermally released gas of 1300 ng/cm² or less (in particular, 0 to 1300 ng/cm²) when determined at 80° C. for 3 hours by GC-MS. The PSA sheet with such highly-limited thermal gas release can be preferably used in an application, for instance, a magnetic disc device, for which the presence of volatile gas is undesirable. When the PSA sheet satisfying this property is used in the interior or in an area in contact with the interior (e.g. in an area dividing the interior and the exterior) of a magnetic disc device, it can highly inhibit internal contamination with siloxane and other gas that affect the device. The amount of thermally released gas is preferably less than 1000 ng/cm², more preferably less than 800 ng/cm², or yet more preferably less than 500 ng/cm². In some embodiments, the amount of thermally released gas can be, for instance, less than 350 ng/cm², less than 200 ng/cm², or even less than 150 ng/cm².

The amount of thermally released gas is determined based on the dynamic headspace method. In particular, a PSA sheet subject to measurement is cut out to a 7 cm² size to obtain a measurement sample. The measurement sample is sealed in a 50 mL vial and heated at 80° C. for 3 hours, using a headspace autosampler. As the headspace autosampler, a commercial product can be used without particular limitations. For instance, product name EQ-12031HSA available from JEOL Ltd., or a comparable product can be used. The total amount of gas released from the measurement sample is determined by gas chromatography/mass spectrometry (GC-MS). A commercial GC-MS can be used. The amount of thermally released gas is the amount of gas released per unit surface area of PSA sheet (in ng/cm²). The same measurement method is employed in the working examples described later.

The PSA sheet disclosed herein preferably has a peel distance less than 50 mm under a 30 g load applied for one hour in a constant load peel test. The PSA sheet with a small peel distance can resist stress (internal strain) that remains after laser machining by means of sort of thermal shrinkage associated with the laser machining, thereby better inhibiting the lifting and displacement of the PSA sheet due to the remaining stress. By this, components can be more precisely fastened or positioned. The peel distance can be, for instance, less than 40 mm, less than 3.5 mm, less than 30 mm, less than 20 mm, or less than 15 mm. In some embodiments, the peel distance can be less than 10 mm, less than 5 mm, or less than 3 mm. Alternatively; in view of the balance with other properties, in some embodiments, the peel distance can be, for instance, 10 mm or greater, 15 mm or greater, or even 20 mm or greater.

The peel distance in the constant load peel test is determined by the following method. In particular, a PSA sheet of interest is cut into a 20 mm wide by 150 mm long size to obtain a measurement sample. In an environment at 23° C., and 50% RH, the measurement sample is press-bonded to a stainless steel plate as the adherend with a 2 kg roller moved back and forth once. This is left standing in the same environment for 30 minutes. Subsequently the adherend is horizontally held with the face bearing the measurement sample at the bottom. To one end of the measurement sample, a 30 g load is applied to obtain a peel angle of 90°. The peel distance of the measurement sample (the length of the measurement sample that peeled of) is measured at one hour after the load was applied. The same measurement method is employed in the working examples described later.

The PSA sheet disclosed herein preferably has an amount of silicone in adhesive face of 20 ng/cm² or less, that is, an amount of silicone based on polydimethylsiloxane standards and the X-ray intensity of silicon obtained by X-ray fluorescence analysis of the PSA layer surface. According to such a PSA sheet, the release of siloxane gas from the PSA sheet can be greatly inhibited. In some embodiments, the amount of silicone in adhesive face can be, for instance, 10 ng/cm² or less, 5 ng/cm² or less, 2 ng/cm² or less, or even 0 ng/cm². It is noted that examples of causes that increase the amount of silicone in adhesive face include the transfer of silicone from a release face (typically the release liner surface or the substrate's backside) that had been in contact with the adhesive face for protection until the PSA sheet is used, the transfer of silicone from a release liner (process liner) that is used in an embodiment where it is temporarily brought in contact with the adhesive face in a production process of the PSA sheet, and the use of a silicone-based additive in the PSA composition used for forming the PSA layer (e.g. addition of defoaming agent and leveling agent to an emulsion-based PSA composition).

The amount of silicone in adhesive face is determined by the following method. In particular, of the PSA sheet of interest, the adhesive face is exposed: by X-ray fluorescence analysis, the amount of Si present in an area equivalent to a circle of 30 mm diameter is determined in X-ray intensity (cps, counts per second). Based on the X-ray intensity (cps) obtained, the amount of silicone in adhesive face is determined in ng/cm² based on polydimethylsiloxane standards. For the conversion, 100 kcps=0.60 g/m² is used. The same measurement method is used in the working examples described later. The X-ray fluorescence analysis can be conducted using a commercial X-ray fluorescence spectrometer. In the working examples described later, product name 7SX100E (available from Rigaku Co., Ltd.) was used to determined X-ray intensities, with Rh as the X-ray source and RX-4 as the dispersive crystal at 50 kV and 70 mA output.

The PSA sheet disclosed herein preferably has a tensile modulus per unit width in a prescribed range. In particular, the tensile modulus is suitably greater than 500 N/cm, preferably greater than 800 N/cm, more preferably greater than 1250 N/cm, yet more preferably greater than 1400 N/cm, greater than 1500 N/cm or even greater than 1600 N/cm. The PSA sheet having such a tensile modulus has suitable rigidity; and therefore, it can be preferably used in an embodiment where placement and installation of a component are carried out using a through hole and a notch made in the PSA sheet. In a preferable embodiment, the through hole and notch can be formed after the PSA sheet is applied to an adherend, by subjecting the PSA sheet (preferably an area where the PSA sheet does not make contact with the adherend, e.g. an area covering an opening in the adherend) to laser machining. In such an application, especially great effect can be obtained from the use of the PSA sheet disclosed herein. The maximum tensile modulus is not particularly limited and can be suitably selected in accordance with the application of the PSA sheet, etc. In some embodiments, the tensile modulus per unit width of PSA sheet can be, for instance, about less than 8000 N/cm; it is usually suitably less than 5000 N/cm, preferably less than 3500 N/cm, more preferably less than 3000 N/cm, or possibly even less than 2500 N/cm. From the standpoint of the handling properties of the PSA sheet and the ease of picking it up from the release liner, etc., it can be advantageous that the PSA sheet does not have an excessively high tensile modulus per width.

The tensile modulus per unit width of PSA sheet is determined as follows: In particular, the PSA sheet is cut to a 10 mm wide, 50 mm long strip to prepare a test piece. The two ends of the length of the test piece are clamped with chucks in a tensile tester. In an atmosphere at 23° C., at an inter-chuck distance of 20 mm, at a speed of 50 mm/min, a tensile test is conducted using the tensile tester to obtain a stress-strain curve. Based on the initial slope of the resulting stress-strain curve, the Young's modulus (N/mm²=MPa) is determined by linear regression of the curve between two specified strain points ε1 and ε2. From the product of the resulting value and the thickness of the PSA sheet, the tensile modulus per unit width (N/cm) can be determined. As the tensile tester, a commonly known or conventionally used product can be used. For instance, AUTOGRAPH AG-IS available from Shimadzu Corporation or a comparable product can be used.

The PSA sheet disclosed herein preferably has a 1800 peel strength to stainless steel (adhesive strength) of 2 N/20 mm or greater when determined based on JIS Z 0237:2009. Having such an adhesive strength, the PSA sheet can bond well to an adherend, making it highly reliable for fastening and bonding components. The adhesive strength is more preferably 5 N/20 mm or greater, yet more preferably 7 N/20 mm or greater, or possibly even 10 N/20 mm or greater. The maximum adhesive strength is not particularly limited. From the standpoint of preventing leftover adhesive residue, the adhesive strength can be about 20 N/20 mm or less, or even about 15 N/20 mm or less.

The adhesive strength of a PSA sheet is determined by the following method: A PSA sheet subject to measurement is cut to a 20 mm wide, 100 mm long size to prepare a test piece. In an environment at 23° C., and 50% RH, the adhesive face of the test piece is press-bonded to a stainless steel plate (SUS304BA plate) to obtain a measurement sample. The press-bonding is carried out by rolling a 2 kg roller back and forth once. The measurement sample is left standing in an environment at 23° C., and 50% RH for 30 minutes. Subsequently, using a tensile tester, based on JIS Z 0237:2009, the peel strength (N/20 mm) is determined at a tensile speed of 300 mm/min at a peel angle of 180°. As the tensile tester, Precision Universal Tensile Tester Autograph AG-IS 50N available from Shimadzu Corporation or a comparable product can be used.

The total thickness of the PSA sheet disclosed herein is not particularly limited. It can be, for instance, about 10 μm or greater. From the standpoint of making it easier to combine good shape-stability and good adhesive properties (e.g. a small peel distance in a constant load peel test), the total thickness of the PSA sheet is suitably about 15 μm or greater, preferably 25 μm or greater, more preferably 45 μm or greater, or yet more preferably 65 μm or greater, or even 70 μm or greater. From the standpoint of making it thinner and lighter in weight, the total thickness of the PSA sheet is usually suitably about 500 μm or less, 300 μm or less, 200 μm or less, or even 150 μm or less. The total thickness of the PSA sheet here refers to the combined thickness of the substrate and the PSA layer, not including the thickness of the release liner described later.

### <Substrate>

As the substrate of the PSA sheet disclosed herein, resin film, foam film, paper, cloth, metal foil, a composite and laminate of these, and the like can be used while it is not limited to these. From the standpoint of avoiding formation of lint, a preferable substrate is free of a fiber layer such as paper and cloth. From the standpoint of the ease of laser cutting, a substrate comprising resin film can be preferably used. Examples of the resin material forming the resin film include polyester resins such as polyethylene terephthalate (PET) and polybutylene terephthalate (PBT); and polyolefin resins such as polyethylene, polypropylene, ethylene-propylene copolymer, and polypropylene-polyethylene blend resin: as well as vinyl chloride resin (typically soft vinyl chloride resin), vinyl acetate resin, and polyamide-based resins; however, it is not limited to these. The substrate may have a monolayer structure or a multilayer structure including two or more layers. Monolayer substrates can be advantageous in terms of productivity and quality consistency of the substrate. On the other hand, multilayer substrates have advantages such that, for instance, functions and appearances can be easily varied between the front face (the face adhered to adherend) and the backside.

The substrate preferably includes a laser-absorbing layer. The laser-absorbing layer is typically a layer that includes a laser absorber in a resin. Non-limiting examples of the material that can be used as the resin include polyester resins such as polyethylene terephthalate (PET) and polybutylene terephthalate (PBT); and polyolefin resins such as polyethylene, polypropylene, ethylene-propylene copolymer, and polypropylene-polyethylene blend resin; as well as vinyl chloride resin, vinyl acetate resin, and polyamide-based resins. A resin composition obtained by adding a laser absorber to such a resin material can be typically molded into film to form a laser-absorbing layer.

As the laser absorber, various materials capable of increasing the laser absorbance in the wavelength range of 1000 nm to 1100 nm can be used. The number of species of laser absorber in the substrate can be one, two or more. In the PSA sheet comprising two or more species of laser absorber, they can be blended for use or included in different layers of the substrate, respectively:

Examples of the laser absorber include carbon materials such as carbon black and carbon fiber: metals such as aluminum, iron, titanium, nickel, zirconium, tungsten, copper, silver, gold, zinc, molybdenum and chromium as well as alloys (e.g. stainless steel) comprising these as primary components; metal compounds such as oxides of these metals (e.g, titanium oxide, aluminum oxide, etc.), nitrides, and carbides; and organic compounds such as phthalocyanine-based compounds, cyanine-based compounds, aluminum-based compounds, naphthalocyanine-based compounds, naphthoquinone-based compounds, diimmonium-based compounds, anthraquinone-based compounds, and aromatic (diol-based metal complexes (e.g. nickel complexes). In the laser-absorbing layer that comprises the laser absorber in a resin composition, as the laser absorber, it is preferable to use a material having a higher thermal decomposition temperature than the resin component forming the laser-absorbing layer.

When using a particulate laser absorber (laser-absorbing powder), the particulate shape is not particularly limited: it can be flaky spherical, needle-like, polyhedral or irregularly shaped. In typical, it is preferable to use a laser-absorbing powder in a flaky spherical or needle-like form. The mean particle diameter of the laser absorbing powder is not particularly limited: it can be, for instance, 0.01 μm or greater and 20 μm or less. In some embodiments, the mean particle diameter of the laser absorbing powder can be, for instance, 0.1 μm or greater, 0.5 μm or greater: it can be 10 μm or less, or even 5 μm or less. In the present description, unless otherwise specified, the term “mean particle diameter” refers to the 50th-percentile particle diameter (50% volume average mean particle diameter or it may be abbreviated as D₅₀) in its size distribution obtained by a particle size meter based on laser scattering/diffraction.

In some embodiments, the laser-absorbing layer may include carbon black as the laser absorber. For instance, carbon black having a mean particle diameter of 10 nm to 500 nm (more preferably 10 nm to 120 nm) can be used. Carbon black can be used alone or together with other laser absorber(s).

In some embodiments, the laser-absorbing layer may include, as the laser absorber, at least a metal powder or a metallic compound powder. Such a laser absorber is preferable because it can endure the temperature rise associated with laser absorption and suitably maintain the ability to absorb the laser light. Favorable examples of this type of laser absorber include titanium oxide powder, aluminum oxide powder, and metal aluminum powder.

The amount of laser absorber used is not, particularly limited. In some embodiments, the laser absorber can be used in an amount of, for instance, 0.01% by weight or more of the laser-absorbing layer that includes the laser absorber, 0.05% by weight or more, or even 0.1% by weight or more. From the standpoint of reducing the remaining residue from the laser cutting and lowering the reflectance, in some embodiments, the laser absorber content can be, for instance, 10% by weight or less, 5% by weight or less, 3% by weight or less, or even 2% by weight or less of the laser absorbing layer that includes the laser absorber.

The method for forming the substrate is not particularly limited and heretofore known extrusion (e.g. inflation extrusion), casting and like method can be suitably employed. The substrate can be unstretched or stretched uniaxially biaxially etc. The substrate having several resin layers including the laser-absorbing layer can be obtained by a single method or a suitable combination of methods among a method for simultaneously molding resin compositions corresponding to the respective resin layers (e.g. multilayer inflation molding), a method where layers are individually molded and then adhered to each other, a method where another layer is casted on top of a pre-molded layer, etc. When the substrate includes a resin layer other than the laser-absorbing layer, the resin forming the resin layer can be suitably selected among the same species listed as examples of the resin that can be used for the laser-absorbing layer.

From the standpoint of reducing the thermal shrinkage of the PSA sheet during laser machining, in some embodiments, it is preferable to use a substrate including a layer formed of a polyester resin. Favorable examples of the polyester resin used for the substrate include PET and PBT. Among them, PET is preferable. The layer formed of the polyester resin may include a laser absorber or may be free of a laser absorber. For instance, the PSA sheet disclosed herein can be preferably made in an embodiment having a PSA layer on one face of a monolayer substrate constituted with a laser absorber-containing polyester resin layer (a laser-absorbing layer).

The substrate may include optional additives as necessary Examples of the additives include flame retarder, antistatic agent, photo-stabilizer (radical scavenger, UV absorber, etc.) and antioxidant.

To enhance the tightness of bonding to the PSA layer, etc., the face of the substrate to which the PSA layer is provided may be subjected as necessary to common surface treatment, including chemical or physical treatment, for instance, mattifying treatment, corona discharge treatment, UV irradiation, crosslinking treatment, chromic acid treatment, ozone exposure, flame exposure, high-voltage electric shock exposure, ionized radiation treatment, and primer application. In an embodiment of the single-faced PSA sheet, the substrate's backside (opposite from the side to which the PSA layer is provided) can be subjected to a similar surface treatment or a surface treatment to facilitate the release from the PSA layer. The surface treatment to facilitate the release can be carried out using a known release agent such as a silicone-based release agent, long-chain alkyl-based release agent, and fluorine-based release agent. However, it is desirable to avoid the use of a silicone-based release agent in the PSA sheet used in an application where silicone gas is unwanted. For instance, the amount of silicone in substrate's backside is preferably 20 ng/cm² or less, more preferably 10 ng/cm² or less, or yet more preferably 5 ng/cm² or less, for instance, 0 ng/cm². The art disclosed herein can be preferably implemented in an embodiment where the substrate's backside is not subjected to a surface treatment to facilitate the release.

The substrate's thickness is not particularly limited and can be, for instance, about 5 μm or greater. From the standpoint of the shape stability of the ISA sheet, the substrate's thickness is usually suitably 15 μm or greater, preferably 20 μm or greater, or more preferably 25 μm or greater. From the standpoint of facilitating installation of a component (e.g, the ease of controlling the position and orientation of the component) using the PSA sheet disclosed herein, in some embodiments, the substrate's thickness can be, for instance, 30 μm or greater, 35 μm or greater, or even 45 μm or greater. The maximum thickness of the substrate is not particularly limited. From the standpoint of the adherend conformability and of reducing the thickness and weight, the substrate's thickness is usually suitably about 400 μm or less, 250 m or less, 150 m or less, or even 120 μm or less.

The substrate's tensile modulus per width is not particularly limited. For instance, the substrate's tensile modulus per width can be selected so that the PSA sheet that includes the substrate has a tensile modulus in the preferable range described earlier. In general, the PSA layer has a significantly lower tensile modulus than the substrate: and therefore, the tensile modulus per width of PSA sheet with PSA layer on substrate (e.g. resin film) mostly equals the tensile modulus per width of substrate alone. Accordingly, in the art disclosed herein, the tensile modulus per width of PSA sheet described earlier can be applied as a favorable range of tensile modulus per width of substrate.

### <PSA Layer>

### (Base Polymer)

In the art disclosed herein, the type of PSA forming the PSA layer is not particularly limited. The PSA may comprise, as its base polymer, one, two or more species of various rubber-like polymers such as rubber-based polymers, acrylic polymers, polyester based polymers, urethane-based polymers, polyether-based polymers, silicone-based polymers, polyamide-based polymer and fluorine-based polymers that are known in the PSA field. From the standpoint of the moisture resistance and reduction of outgassing, it is preferable to use a rubber-based PSA comprising a rubber-based polymer as the base polymer or a PSA comprising an acrylic polymer as the base polymer. Other examples include a PSA comprising a rubber-based polymer and an acrylic polymer as the base polymer. In particular, a highly moisture-resistant rubber-based PSA layer is more preferable. When the PSA sheet disclosed herein is used in a magnetic disc device, it is desirable that the PSA is essentially free of a silicone-based polymer which may form siloxane gas.

The PSA sheet having an acrylic PSA layer and the PSA sheet having a rubber-based PSA layer are primarily discussed below; however, the PSA layer of the PSA sheet disclosed herein is not limited to a layer formed of an acrylic PSA or a rubber-based PSA.

As used herein, the “base polymer” of PSA refers to the primary component among rubber-like polymers (i.e. a component accounting for more than 50% by weight of the rubber-like polymers) in the PSA. A rubber-like polymer is a polymer that shows rubber elasticity in a room temperature range.

### (Acrylic Polymer)

In some embodiments of the art disclosed herein, the PSA layer is an acrylic PSA layer comprising an acrylic polymer as a base polymer. The acrylic polymer is preferably a polymer of a starting monomer mixture that comprises an alkyl (meth)acrylate as the primary monomer and may further comprise a secondary monomer copolymerizable with the primary monomer. Here, the primary monomer refers to a component accounting for more than 50% by weight of the starting monomer mixture.

As used herein, the term “(meth)acryloyl” comprehensively refers to acryloyl and methacryloyl. Similarly, the term “(meth)acrylate” comprehensively refers to acrylate and methacrylate, and the term “(meth)acryl” comprehensively refers to acryl and methacryl.

As the alkyl (meth)acrylate, for instance, a compound represented by the following formula (1) can preferably be used:

CH₂═C(R¹)COOR² (1)

Here, R¹ in the formula (1) is a hydrogen atom or a methyl group. R² is an acyclic alkyl group having 1 to 20 carbon atoms (hereinafter, such a range of the number of carbon atoms may be indicated as “C₁₋₂₀”). From the standpoint of the PSA's storage modulus, adhesive properties, etc., an alkyl (meth)acrylate in which RH is a C₁₋₁₈ acyclic alkyl group is preferable; an alkyl (meth)acrylate in which H² is a C₂₋₁₄ acyclic alkyl group is more preferable: an alkyl (meth)acrylate in which R² is a C₄₋₁₂ acyclic alkyl group is even more preferable. In particular, it is preferable to use an alkyl acrylate as the primary monomer. The acyclic alkyl group includes linear and branched alkyl groups.

Examples of an alkyl (meth)acrylate having a C₁₋₂₀ acyclic alkyl group for R² include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isoctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. Among these alkyl (meth)acrylates, solely one species or a combination of two or more species can be used.

From the standpoint of increasing the conversion in the synthesis of the acrylic polymer to facilitate reduction of thermally released gas, as the primary monomer forming the acrylic polymer, an alkyl acrylate having an acyclic alkyl group with 9 or fewer carbon atoms can be preferably used. For instance, it is preferable to use at, least either 2-ethylhexyl acrylate (2EHA) or n-butyl acrylate (BA). In the acrylic polymer, BA may be used solely or 2EHA may be used solely as the primary monomer, or just BA and 2EHA may be used as the primary monomer. A favorable example is an acrylic polymer in which BA is used alone as the primary monomer. In an embodiment of the art disclosed herein, the BA content in all monomers forming the acrylic polymer can be, for instance, 50% by weight or higher, 70% by weight or higher, 85% by weight or higher, or even 90% by weight or higher.

The ratio of alkyl (meth)acrylate as the primary monomer in all the monomers forming the acrylic polymer is preferably 60% by weight or higher, more preferably 70% by weight or higher, or yet more preferably 75% by weight or higher, for instance, 8.5% by weight or higher. The maximum ratio of alkyl (meth)acrylate is not particularly limited. From the standpoint of making it easier to decrease the peel distance in the constant load peel test, the ratio of alkyl (meth)acrylate is usually suitably lower than 98% by weight, or preferably lower than 96% by weight.

Secondary monomers capable of introducing possible crosslinking points into the acrylic polymer or enhancing the adhesive strength include carboxy group-containing monomers, hydroxy group-containing monomers, acid anhydride group-containing monomers, amide group-containing monomers, amino group-containing monomers, imide group-containing monomers, epoxy group-containing monomers, (meth)acryloylmorpholine, and vinyl ethers. Among them, hydroxy group-containing monomers and carboxy group-containing monomers are preferable.

A favorable example of the acrylic polymer in the art disclosed herein is an acrylic polymer in which a carboxy group-containing monomer is copolymerized as the secondary monomer. Examples of the carboxy group-containing monomer include acrylic acid (AA), methacrylic acid (MAA), carboxyethyl (meth)acrylate, carboxypentyl (meth)acrylate, itaconic acid, maleic acid, fumaric acid, crotonic acid, and isocrotonic acid. Among them, AA and MAA are preferable.

The carboxy group-containing monomer content in all monomers can be, for instance, above about 1% by weight, above 3% by weight, above 5% by weight, or even above 6% by weight: it is usually suitably below 15% by weight below 12% by weight, below 10% by weight, or even below 8% by weight.

In the acrylic polymer in the art disclosed herein, a hydroxy group-containing monomer may be copolymerized as the secondary monomer. Examples of the hydroxy group-containing monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, and 4-hydroxybutyl (meth)acrylate: polypropylene glycol mono(meth)acrylate: and N-hydroxyethyl(meth)acrylamide. Particularly preferably hydroxy group-containing monomers include hydroxyalkyl (meth)acrylates having linear alkyl groups with 2 to 4 carbon atoms. For instance, 2-hydroxyethyl acrylate (HEA) and 4-hydroxybutyl acrylate (4HBA) can be preferably used.

The hydroxy group-containing monomer content in all monomers can be, for instance, 0.01% by weight or higher, 0.02% by weight or higher, or even 0.03% by weight or higher; it can be, for instance, 10% by weight or lower, 5% by weight or lower, 1% by weight or lower, 0.5% by weight or lower, or even 0.2% by weight or lower.

For the secondary monomer, solely one species or a combination of two or more species can be used. From the standpoint of the cohesive strength, etc., the secondary monomer content in all monomers is usually suitably higher than 1% by weight, preferably higher than 2% by weight, more preferably higher than 5% by weight, or possibly higher than 6% by weight. The upper limit is preferably 30% by weight or lower (e.g. 25% by weight or lower), 15% by weight or lower, or even 10% by weight or lower.

A favorable example of the acrylic polymer in the art disclosed herein is an acrylic polymer using both a hydroxy group-containing monomer and a carboxy group-containing monomer as the secondary monomers. When these are used together, the ratio (by weight) of carboxy group-containing monomer to hydroxy group-containing monomer can be, for instance, above 3 times, above 10 times, above 30 times, above 70 times, or even above 100 times. With the combined use of the hydroxy group-containing monomer in a small amount relative to the carboxy group-containing monomer, the PSA sheet can be favorably made, suited for positioning, installation and bonding of a component, etc. While no particular limitations are imposed, the ratio can be, for instance, 1000 times or lower, 500 times or lower or even 300 times or lower.

As the monomers forming the acrylic polymer, for a purpose such as increasing the cohesive strength of the acrylic polymer and adjusting the Tg value, other comonomers can be used besides the aforementioned secondary monomers. Examples of the comonomers include vinyl ester-based monomers such as vinyl acetate: aromatic vinyl compounds such as styrene; cycloalkyl (meth)acrylates such as cyclohexyl (meth)acrylate; aromatic ring-containing (meth)acrylates such as aryl (meth)acrylates; olefinic monomers such as ethylene, propylene, isoprene, butadiene and isobutylene: polyfunctional monomers such as 1,6-hexanediol di(meth)acrylate, having two or more (e.g, three or more) polymerizable functional groups (e.g. (meth)acryloyl groups) per molecule. The amount of the other comonomers can be suitably selected in accordance to the purpose and application and is not particularly limited. It is usually preferably 10% by weight or less (e.g. 1% by weight or less) of all monomers.

The composition of monomers forming the acrylic polymer is suitably designed so that the acrylic polymer has a glass transition temperature (Tg) of about −5° C., or lower (e.g. about −75° C., or higher and −5° C., or lower). Here, the Tg of an acrylic polymer refers to the value determined by the Fox equation based on the composition of the monomers.

As shown below, the Fox equation is a relational expression between the Tg of a copolymer and glass transition temperatures Tgi of homopolymers of the respective monomers constituting the copolymer.

1/Tg=Σ(Wi/Tgi)

In the Fox equation, Tg represents the glass transition temperature (unit: K) of the copolymer, Wi the weight fraction (copolymerization ratio by weight) of a monomer i in the copolymer, and Tgi the glass transition temperature (unit: K) of homopolymer of the monomer i.

As the glass transition temperatures of homopolymers used for determining the Tg value, values found in publicly known documents are used. For example, with respect to the monomers listed below, as the glass transition temperatures of homopolymers of the monomers, the following values are used:

| | |
|---|---|
| 2-ethylhexyl acrylate | −70° C. |
| n-butyl acrylate | −55° C. |
| ethyl acrylate | −22° C. |
| lauryl acrylate | 0° C. |
| 2-hydroxyethyl acrylate | −15° C. |
| 4-hydroxybutyl acrylate | −40° C. |
| acrylic acid | 106° C. |
| methacrylic acid | 228° C. |

With respect to the glass transition temperatures of homopolymers of monomers other than those listed above, values given in “Polymer Handbook” (3rd edition, John Wiley & Sons, Inc., Year 1989) are used. When the literature provides two or more values, the highest value is used.

While no particular limitations are imposed, from the standpoint of the adhesion, the acrylic polymer's Tg is advantageously about −10° C., or lower, or preferably about −15° C., or lower, more preferably −20° C., or lower, or yet more preferably −35° C., or lower. From the standpoint of the PSA layer's cohesive strength, the acrylic polymer's Tg is advantageously about −75° C., or higher, preferably about −70° C., or higher, more preferably about −55° C., or higher, or possibly even higher than −50° C. The acrylic polymer's Tg can be adjusted by suitably changing the monomer composition (i.e, the monomer species used for synthesizing the polymer and their ratio).

The acrylic polymer's Mw is not particularly limited. For instance, it can be about 10×10⁴ or higher and 500×10⁴ or lower. From the standpoint of reducing the peel distance in the constant load peel test and reducing the amount of outgassing, the Mw is advantageously about 30×10⁴ or higher and preferably about 45×10⁴ or higher (e.g. about 65×10 or higher). In a preferable embodiment, the acrylic polymer's Mw is about 70×10 or higher, more preferably about 90×10⁴ or higher or yet more preferably about 110×10 or higher. From the standpoint of the adhesion, the Mw is usually suitably about 300×10 or lower, preferably about 200×10⁴ or lower, or more preferably about 170×10⁴ or lower.

It is noted that Mw is determined from a value obtained based on polystyrene standards by gel permeation chromatography (GPC). As the GPC analyzer, for instance, model name IILC-8320 GPC (columns: TSKgel GMH-H(S) available from Tosoh Corporation) can be used.

The method for obtaining the acrylic polymer is not particularly limited. Various polymerization methods known as synthetic methods of acrylic polymers may be appropriately employed, such as solution polymerization, emulsion polymerization, bulk polymerization, suspension polymerization and photopolymerization. For instance, solution polymerization may be preferably employed. As the method for supplying the monomers when solution polymerization is carried out, all-at-once supply by which all starting monomers are supplied at once, continuous supply (addition), portion-wise supply (addition) and like method can be suitably employed. From the standpoint of making it easier to form a PSA layer with a low level of thermally released gas, it is preferable to set the polymerization conditions (polymerization time, polymerization temperature, etc.) so as to obtain a polymerization reaction mixture with less unreacted monomers.

The polymerization temperature can be appropriately selected according to the species of monomers, solvent, and polymerization initiator used, etc. It can be, for instance, about 20° C., to 170° C. (typically about 40° C., to 140° C.). In a preferable embodiment, the polymerization temperature can be about 75° C., or lower (more preferably about 65° C., or lower. e.g. about 45° C., to 65° C.). After polymerization is carried out at such a polymerization temperature, the internal temperature of the system can be maintained at a higher temperature (e.g. a temperature higher by about 5° C., to 35° C., or by about 10° C., to 20° C.) for, for instance, about 15 minutes to 6 hours or preferably about 30 minutes to 3 hours to reduce unreacted monomers.

For the solvent (polymerization solvent) used for solution polymerization, a suitable species can be selected among heretofore known organic solvents. For instance, it is possible to use one species of solvent or a solvent mixture of two or more species, selected among aromatic compounds (typically aromatic hydrocarbons) such as toluene and xylene; acetic acid esters such as ethyl acetate; and aliphatic or alicyclic hydrocarbons such as hexane and cyclohexane: lower alcohols such as methanol, ethanol and isopropanol: and ketones such as methyl ethyl ketone. From the standpoint of readily obtaining a PSA sheet with a low amount of thermally released gas, it is preferable to use a polymerization solvent that can be easily removed by volatilization. For instance, it is preferable to use one solvent species (ethyl acetate, etc.) having a boiling point below 100°, below 90° C., or below 80° C., or a solvent mixture having a composition that gives such a boiling point.

The initiator used for the polymerization may be suitably selected according to the polymerization method from heretofore known polymerization initiators. Examples include azo-based polymerization initiators such as 2,2′-azobisisobutyronitrile, 2,2-azobis-2-methylbutyronitrile, dimethyl 2,2-azobis(2-methylpropionate), 4,4′-azobis-4-cyanovalerianic acid, azobis isovaleronitrile, 2,2′-azobis(2-amidinopropane) dihydrochloride, 2,2′-azobis[2-(5-methyl-2-imidazolin-2-yl)propane] dihydrochloride, 2,2′-azobis(2-methylpropionamidine) disulfate, and 2,2′-azobis(N,N-dimethyleneisobutylamidine) dihydrochloride; persulfates such as potassium persulfate; peroxide-based polymerization initiators such as dibenzoyl peroxide; substituted ethane-based initiators such as phenyl-substituted ethane: aromatic carbonyl compounds: and redox-based initiators by a combination of a peroxide and a reducing agent. For the polymerization initiator, solely one species or a combination of two or more species can be used. The polymerization initiator can be used in a typical amount selected from a range of, for instance, about 0.005 part to 1 part (typically about 0.01 part to 1 part) by weight to 100 parts by weight of the monomers.

The art disclosed herein, as the polymerization initiator, an azo-based polymerization initiator can be preferably used. In radical polymerization, as compared to organic peroxides and other radial polymerization initiators, it is advantageous to use an azo-based polymerization initiator as its degradation products are unlikely to remain in the resulting PSA composition as components that can be thermally released gas and outgassing is likely to be inhibited. As the polymerization initiator, it is particularly desirable to avoid the use of an organic peroxide. It is preferable to synthesize the acrylic polymer in the art disclosed herein, for instance, using only one, two or more species of azo-based initiators as the polymerization initiator.

### (Rubber-Based Polymer)

In some embodiments of the art disclosed herein, the PSA layer is preferably a rubber-based PSA layer formed from a PSA composition that comprises a rubber-based polymer as the base polymer. Examples of the base polymer include various rubber-based polymers such as natural rubber; styrene-butadiene rubber (SBR); polyisoprene; a butene-based polymer comprising butene (referring to 1-butene as well as cis- or trans-2-butene) and/or 2-methylpropene (isobutylene) as the primary monomer(s); A-B-A block copolymer rubber and a hydrogenation product thereof, for instance, styrene-butadiene-styrene block copolymer rubber (SBS), styrene-isoprene-styrene block copolymer rubber (SIS), styrene-isobutylene-styrene block copolymer rubber (SIBS), styrene-vinyl isoprene-styrene block copolymer rubber (SVIS), styrene-ethylene-butylene-styrene block copolymer rubber (SEBS) which is a hydrogenation product of SBS, styrene-ethylene-propylene-styrene block copolymer rubber (SEPS) which is a hydrogenation product of SIS, and styrene-isoprene-propylene-styrene block copolymer (SIPS). Among these rubber-based polymers, solely one species or a combination of two or more species can be used.

A favorable example of the butene-based polymer is an isobutylene-based polymer. Due to its molecular structure, the isobutylene-based polymer's main chain has low motility. Thus, a PSA layer (isobutylene-based PSA layer) whose base polymer is an isobutylene-based polymer may itself show a relatively low level of gas diffusion. This is advantageous from the standpoint of preventing entry of moisture (water vapor) into electronic devices through the PSA layer, preventing gas leakage from an electronic device filled with a gas (e.g. a magnetic disc device having a housing base internally filled with helium gas), etc. Such a PSA layer tends to have a good elastic modulus and excellent removability. Specific examples of the isobutylene-based polymer include polyisobutylene and isobutylene-isoprene copolymer (butyl rubber).

The monomers (monomer mixture) to form the rubber-based polymer disclosed herein comprises one, two or more species of monomers selected among butene, isobutylene, isoprene, butadiene, styrene, ethylene and propylene. The rubber-based polymer can be a polymer obtainable by polymerizing the one, two or more species of monomers exemplified above. The monomer mixture for forming the rubber-based polymer disclosed herein typically comprises the one, two or more species of monomers at a ratio of at least 50% (e.g. 50% to 100%) by weight, preferably at least 75% by weight, more preferably at least 85% by weight, or yet more preferably at least 90% (e.g. at least 95%) by weight. The ratio of these monomers in the entire monomer content can also be 99% by weight or higher. The rubber-based polymer according to a preferable embodiment is a polymer obtainable by polymerizing one, two or more species of monomers selected among isobutylene, isoprene and butene. It is noted that from the standpoint of reduction of outgassing (in particular, reduction of gas emission that may degrade the durability reliability or accurate operation of electronic devices including magnetic disc devices), the styrene content of the monomer mixture is preferably lower than 10% by weight, or more preferably lower than 1% by weight. The art disclosed herein can be preferably implemented in an embodiment where the monomer mixture is essentially free of styrene.

In a preferable embodiment of the PSA sheet disclosed herein, the isobutylene-based polymer accounts for more than 50% (e.g. 70%6 or more, or even 85% or more) by weight of the polymer(s) in the PSA. The PSA may be essentially free of other polymers besides the isobutylene-based polymer. In the PSA, for instance, the ratio of non-isobutylene-based polymer content in the polymer content can be 1% by weight or lower, or at or below the minimum detectable level.

As used herein, the “isobutylene-based polymer” is not limited to isobutylene homopolymer (homopolyisobutylene) and the term encompasses a copolymer whose primary monomer is isobutylene. The copolymer includes a copolymer in which isobutylene corresponds to the highest content of the monomers forming the isobutylene-based polymer. In typical, it can be a copolymer in which isobutylene accounts for more than 50% by weight of the monomers, or even 70% by weight or more thereof. Examples of the copolymer include a copolymer of isobutylene and butene (normal butylene), a copolymer (butyl rubber) of isobutylene and isoprene, vulcanized products and modified products of these. Examples of the copolymers include butyl rubbers such as regular butyl rubber, chlorinated butyl rubber, iodinated butyl rubber, and partially crosslinked butyl rubber. Examples of the vulcanized and modified products include those modified with functional groups such as hydroxy group, carboxy group, amino group, and epoxy group. The isobutylene-based polymer that can be preferably used from the standpoint of the moisture resistance, reduction of outgassing, and adhesive strength, etc., includes polyisobutylene and isobutylene-isoprene copolymer (butyl rubber). The copolymer can be a copolymer (e.g. an isobutylene-isoprene copolymer) of which the other monomers (isoprene, etc.) excluding isobutylene has a copolymerization ratio lower than 30% by mol.

As used herein, the “polyisobutylene” refers to a polyisobutylene in which the copolymerization ratio of monomers excluding isobutylene is 10% or lower (preferably 5% or lower) by weight. In particular, homopolyisobutylene is preferable.

The molecular weight of the isobutylene-based polymer is not particularly limited. For instance, it is possible to suitably select and use a species having a weight average molecular weight (Mw) of about 5×10 or higher (preferably about 15×10⁴ or higher, e.g. about 30×10⁴ or higher). The maximum Mw is not particularly limited and can be about 150×10 or lower (preferably about 100×10⁴ or lower, e.g. about 80×10⁴ or lower). Several species of isobutylene-based polymer varying in Mw can be used together as well. Having a Mw in these ranges, the PSA can be easily adjusted to have an elasticity in a preferable range and is likely to show good cohesive strength.

While no particular limitations are imposed, as the polyisobutylene, it is possible to preferably use a species having a dispersity (Mw/Mn) (which is indicated as a ratio of weight average molecular weight (Mw) to number average molecular weight (Mn)) in a range of 3 to 7 (more preferably 3 to 6. e.g. 3.5 to 5.5). Several species of polyisobutylene varying in Mw/Mn can be used together as well.

The Mw and Mn values of an isobutylene-based polymer here refer to values based on standard polystyrene that are determined by gel permeation chromatography (GPC) analysis. As the GPC analyzer, for instance, model name HLC-8120 GPC available from Tbsoh Corporation can be used.

When using a butyl rubber, its molecular weight is not particularly limited. For instance, a species having a Mw in a range of 5×10⁴ to 100×10⁴ can be suitably selected and used. In view of the balance between the PSA layer's ease of formation and tightness of bonding to adherend (adhesive strength), the butyl rubber's Mw is preferably 10×10⁴ or higher, or more preferably 15×10⁴ or higher, it is preferably 100×10 or lower, or more preferably 80×10⁴ or lower. Several species of butyl rubber varying in Mw can be used together as well.

While no particular limitations are imposed, the butyl rubber has a dispersity (Mw/Mn) in a range of preferably 3 to 8 or more preferably in a range of 4 to 7. Several species of butyl rubber varying in Mw/Mn can be used together as well. The butyl rubber's Mw and Mn can be determined by GPC analysis, similarly to the polyisobutylene.

The Mooney viscosity of the butyl rubber is not particularly limited. For instance, a butyl rubber having a Mooney viscosity ML₁₊₈(125° C.) between 10 and 100 can be used. In view of the balance between the PSA layer's ease of formation and tightness of bonding to adherend (adhesive strength), a butyl rubber having a Mooney viscosity ML₁₊₈(125° C.) of 15 to 80 (more preferably 30 to 70, e.g. 40 to 60) is preferable.

The rubber-based PSA layer according to some preferable embodiments comprises a rubber-based polymer A and a rubber-based polymer B as its base polymers. The rubber-based polymers A and B are preferably both isobutylene-based polymers. The rubber-based polymer A according to a more preferable embodiment is an isobutylene-based polymer in which isobutylene is polymerized at a ratio of at least 50% (e.g. at least 70%, preferably at least 80%, or yet more preferably at least 90%) by weight: it is typically polyisobutylene. The rubber-based polymer B is an isobutylene-based polymer in which isobutylene and isoprene are copolymerized (i.e. an isobutylene-based copolymer); it is typically an isobutylene-isoprene copolymer. In the copolymer, the combined amount of isobutylene and isoprene as monomers accounts for typically at least 50% (e.g. at least 70%, preferably at least 80%, or yet more preferably at least 90%) by weight of the entire monomers. The use of rubber-based polymers A and B can bring the PSA layer's elastic modulus in a preferable range, whereby greater moisture resistance and gas-blocking properties tend to be obtained.

When rubber-based polymers A and B are used, their blend ratio can be suitably selected so as to obtain desired properties disclosed herein. The weight ratio (P_{A}/P_{B}) of rubber-based polymer A (P_{A}) to rubber-based polymer B (P_{B}) can be, for instance, 95/5 to 5/95, preferably 90/10 to 10/90, more preferably 80/20 to 20/80, yet more preferably 70/30 to 30/70, or particularly preferably 60/40 to 40/60.

In a preferable embodiment, the dispersity (Mw/Mn) of the aforementioned base polymers at large is 3 or higher, or more preferably 4 or higher. According to the PSA comprising such base polymers, adhesive strength can be easily combined with resistance to leftover adhesive residue. It also brings the PSA layer's elastic modulus in a favorable range and good moisture resistance tends to be obtained. At or above a certain Mw/Mn value, the PSA can be obtained with a low solution viscosity for its Mw. The dispersity of the base polymers at large can also be 5 or higher, 6 or higher, or even 7 or higher. The maximum dispersity of the base polymers at large is not particularly limited; it is preferably 10 or lower (e.g. 8 or lower).

The art disclosed herein can be preferably implemented in an embodiment having a PSA layer (e.g. a rubber-based PSA layer) formed of a PSA (a non-crosslinked PSA) in which the based polymers are not crosslinked. Here, the term “PSA layer formed of a non-crosslinked PSA” refers to a PSA layer that has not been subjected to an intentional treatment (i.e. crosslinking treatment, e.g. addition of a crosslinking agent, etc.) for forming chemical bonds among the base polymers.

The rubber-based PSA layer in the art disclosed herein comprises an aforementioned rubber-based polymer A as the base polymer and may further comprise a polymer C having a lower molecular weight than the polymer A. In terms of the molecular weight, Mw is used for comparison to the polymer A. The polymer C preferably has a Mn of 1000 or higher. By this, the amount of outgassing can be limited while obtaining the effect of using the polymer C. In addition, the peel distance in the constant load peel test can be maintained at a practical level. The polymer C's Mn is preferably 2000 or higher, or more preferably 2500 or higher. The maximum molecular weight of the polymer C is not particularly limited as long as it is lower than that of the polymer A, but the Mw is typically lower than 5×10⁴. The polymer C′s Mw can be lower than about 1×10⁴, or even about 5000 or lower. The polymer C according to an embodiment is a liquid or a viscous fluid at room temperature (e.g. 25° C.).

For the Mn of polymer C, the value determined by vapor pressure osmometry is used. The Mw of polymer C refers to the value based on polystyrene standards determined by gel permeation chromatography (GPC) analysis. As the (GPC analyzer, for instance, model name HLC-8120 GPC available from Tosoh Corporation can be used.

The species of polymer C is not particularly limited and a suitable species is selected in accordance with the species of polymer A, etc. As the polymer C, one, two or more species can be used among, for instance, rubber-based polymers (typically diene-based polymers), olefinic polymers, acrylic polymers, polyester-based polymers, urethane-based polymers, polyether-based polymers, silicone-based polymers, polyamide-based polymers, and fluoropolymers. In the PSA sheet for use in a magnetic disc, it is desirable to avoid the use of a silicone-based polymer.

The polymer C according to a preferable embodiment is selected among olefinic polymers and diene-based polymers. Presumably these polymers are likely to block passage of water molecules because they generally have low polarity with short side chains. In addition, they tend to readily dissolve or disperse in the PSA layer that includes the polymer A. In particular, olefinic polymers are more preferable as they are thermally stable and highly weather resistant. The monomers for forming the polymer C can be one, two or more species of monomers selected among ethylene, propylene, butene, isobutylene, isoprene and butadiene. Here, the butene encompasses 1-butene as well as cis- and trans-2-butenes. The polymer C is preferably a polymer formed from a monomer mixture that includes one, two or more species of the monomers exemplified above at a ratio of at least 50% by weight. Specific examples include ethylene-butene copolymer, ethylene-propylene-butene copolymer, propylene-butene copolymer, ethylene-butene-unconjugated diene copolymer, and ethylene-propylene-butene-unconjugated diene copolymer. Examples of these polymers include so-called ethylene propylene rubber.

In a more preferable embodiment, the polymer C is a polymer formed from a monomer mixture that includes at least one species of monomer at a ratio of at least 50% by weight, selected from the group consisting of butene, isobutylene and isoprene. The polymer obtained from these monomers is hydrophobic and non-polar: and therefore, it is likely to bring about excellent moisture resistance. The monomer mixture to form the polymer C includes one, two or more species of the monomers at a ratio of more preferably at least 75% by weight, yet more preferably at, least 85% by weight, or particularly preferably at least 90% (e.g. at least 95%) by weight. The ratio of these monomers in the entire monomers can also be 99% by weight or more. The polymer C may be obtained by copolymerizing one, two or more species of other monomers (e.g. butadiene, styrene, ethylene, and propylene) copolymerizable with the monomers exemplified above.

In a particularly preferable embodiment, the polymer C is a polybutene, that is, a polymer formed from a monomer mixture that includes a monomer selected among butene (1-butene, cis- or trans-2-butene) and isobutene (isobutylene) at a ratio of at least 50% by weight. The polymerization ratio of butene and isobutene combined in the polybutene as the polymer C is preferably about 75% by weight or higher, more preferably about 85% by weight or higher, or yet more preferably about 90% by weight or higher (e.g. about 95% by weight or higher). The butene and isobutene content in the entire monomers can also be 99% by weight or higher.

The polybutene is a polymer formed from a monomer mixture that includes isobutene as the primary component and may arbitrarily include a certain amount of normal butene (1-butene, cis- or trans-2-butene). Polybutene is thermally stable and highly weather resistant because, unlike diene-based rubber, its molecular chain is free of a double bond. In addition, because of its molecular structure, the main chain is poorly mobile: and therefore, it provides excellent gas-blocking properties and moisture resistance as well. The copolymerization ratio of isobutene in the polybutene is preferably about 50% by weight or higher, more preferably about 70% by weight or higher, or possibly about 80% by weight or higher (e.g. about 90% by weight or higher).

The polymer C can be obtained by a method suitably selected from various known polymerization methods. Alternatively; a commercial product corresponding to the polymer C can be obtained and used. For instance, a polybutene can be obtained by polymerizing a monomer mixture that includes butene and isobutene with the use of a Lewis acid catalyst (e.g. aluminum chloride, boron trifluoride), etc. Alternatively, a species corresponding to the polymer C can be selected and used among commercial products such as the NISSEKI POLYBUTENE series available from JXTG Nippon Oil & Energy Corporation and the NICHIYU POLYBUTENE series available from NOF Corporation.

In the PSA layer disclosed herein, the ratio (C_{C}/C_{A}) of polymer C content (C_{C}) to polymer A content (C_{A}) is suitably about 0.1 or higher. From the standpoint of the gas-blocking properties and moisture resistance, the C_{C}/C_{A} ratio is preferably about 0.3 or higher, more preferably about 0.5 or higher, or yet more preferably about 0.7 or higher (e.g. about 0.9 or higher). The C_{C}/C_{A} ratio is suitably about 2 or lower. From the standpoint of inhibiting a decrease in holding power, the C_{C}/C_{A} ratio is preferably about 1.5 or lower, or more preferably about 1.2 or lower (e.g. about 1.1 or lower).

The polymer C content in the PSA layer is suitably selected in view of the effect of polymer C. From the standpoint of the gas-blocking properties and moisture resistance, the polymer C content in the PSA layer can be, for instance, about 1% by weight or higher, 5% by weight or higher, 15% by weight or higher, 25% by weight or higher, or even 35% by weight or higher. From the standpoint of reducing the amount of thermally released gas and reducing the peel distance in the constant load peel test, the polymer C content in the PSA layer is suitably about 70% by weight or lower, or preferably about 60% by weight or lower (e.g. about 55% by weight or lower). In some embodiments, the polymer C content in the PSA layer can be, for instance, 50% by weight or less, less than 30% by weight, less than 20% by weight, or even less than 10% by weight.

### (Blend of Acrylic Polymer and Rubber-Based Polymer)

The PSA layer according to an embodiment of the art disclosed herein is a rubber-acrylic blend PSA layer comprising a rubber-based polymer and an acrylic polymer as the base polymer. As the rubber-based polymer, one, two or more species can be used among the aforementioned rubber-based polymers. As the acrylic polymer, one, two or more species can be used among the aforementioned acrylic polymers. The rubber based polymer and acrylic polymer can be suitably mixed together to preferably combine the rubber-based polymer's advantage (gas-blocking properties, moisture resistance, etc.) and acrylic polymer's advantage (low level of outgassing, adhesive properties, etc.). When a rubber-based polymer and an acrylic polymer are used together as the base polymer, the weight ratio of rubber-based polymer (R) to acrylic polymer (A), R/A, can be, for instance, 95/5 to 20/80; it is preferably 90/10 to 30/70, more preferably 80.20 to 40/60, or yet more preferably 70/30 to 50/50.

### (Crosslinking Agent)

The PSA composition (preferably a solvent-based PSA composition) used for forming the PSA layer preferably comprises a crosslinking agent as an optional component. The PSA layer (e.g. an acrylic PSA layer) in the art disclosed herein may include the crosslinking agent in a post-crosslinking-reaction form, a pre-crosslinking-reaction form, a partially-crosslinked form, an intermediate or combined form of these, etc. In typical, the crosslinking agent is mostly included in the SA layer in the post-crosslinking-reaction form.

The type of crosslinking agent is not particularly limited. A suitable species can be selected and used among heretofore known crosslinking agents. Examples of the crosslinking agent include isocyanate-based crosslinking agents, epoxy-based crosslinking agents, oxazoline-based crosslinking agents, aziridine-based crosslinking agents, melamine-based crosslinking agents, carbodiimide-based crosslinking agents, hydrazine-based crosslinking agents, amine-based crosslinking agents, peroxide-based crosslinking agents, metal chelate-based crosslinking agents, metal alkoxide-based crosslinking agents, and metal salt-based crosslinking agents. For the crosslinking agent, solely one species or a combination of two or more species can be used. From the standpoint of inhibiting outgassing, it is desirable to select the crosslinking agent from non-peroxide compounds. Examples of the crosslinking agent that can be preferably used in the art disclosed herein include isocyanate-based crosslinking agents and epoxy-based crosslinking agents. In particular, isocyanate-based (crosslinking agents are more preferable.

As the isocyanate-based crosslinking agent a polyfunctional isocyanate (which refers to a compound having an average of two or more isocyanate groups per molecule, including a compound having an isocyanurate structure) can be preferably used. For the isocyanate-based crosslinking agent, solely one species or a combination of two or more species can be used. A preferable example of the polyfunctional isocyanate has an average of three or more isocyanate groups per molecule. Such a tri-functional or higher polyfunctional isocyanate can be a multimer (e.g. a dimer or a trimer), a derivative (e.g., an addition product of a polyol and two or more polyfunctional isocyanate molecules), a polymer or the like of a di-functional, tri-functional, or higher polyfunctional isocyanate. Examples include polyfunctional isocyanates such as a dimer and a trimer of a diphenylmethane diisocyanate, an isocyanurate (a cyclic trimer) of a hexamethylene diisocyanate, a reaction product of trimethylol propane and a tolylene diisocyanate, a reaction product of trimethylol propane and a hexamethylene diisocyanate, polymethylene polyphenyl isocyanate, polyether polyisocyanate, and polyester polyisocyanate.

As the epoxy-based crosslinking agent, a compound having at least two epoxy groups per molecule can be used without particular limitations. A preferable epoxy-based crosslinking agent has three to five epoxy groups per molecule. For the epoxy-based crosslinking agent, solely one species or a combination of two or more species can be used.

While no particular limitations are imposed, specific examples of the epoxy-based crosslinking agent include N,N,N′,N′-tetraglycidyl-m-xylenediamine, 1,3-bis(N,N-diglycidylaminomethyl)cyclohexane, 1,6-hexanediol diglycidyl ether, polyethylene glycol diglycidyl ether, and polyglycerol polyglycidyl ether.

The crosslinking agent content in the PSA composition disclosed herein is not particularly limited. From the standpoint of the cohesion, to 100 parts by weight of the base polymer (e.g. acrylic polymer), it is suitably about 0.001 part by weight or more, preferably about 0.002 part by weight or more, more preferably about 0.005 part by weight or more, or yet more preferably about 0.01 part by weight or more. From the standpoint of the adhesive strength and elastic modulus, the crosslinking agent content in the PSA composition is, to 100 parts by weight of the base polymer (e.g. acrylic polymer), about 20 parts by weight or less, suitably about 15 parts by weight or less, or preferably about 10 parts by weight or less (e.g. about 5 parts by weight or less).

In an embodiment using an isocyanate-based crosslinking agent, its amount used is not particularly limited. The isocyanate-based crosslinking agent can be used in an amount of, for instance, about 0.5 part by weight or greater and about 10 parts by weight or less to 100 parts by weight of the base polymer (e.g. acrylic polymer). From the standpoint of the cohesion, the amount of isocyanate-based crosslinking agent used to 100 parts by weight of the base polymer (e.g. acrylic polymer) is suitably about 1 part by weight or greater, or preferably about 1.5 parts by weight or greater. The amount of isocyanate-based crosslinking agent used to 100 parts by weight of the base polymer (e.g. acrylic polymer) is suitably about 8 parts by weight or less, or preferably about 5 parts by weight or less (e.g. less than about 4 parts by weight).

The PSA layer may include, as necessary, a laser absorber. As the laser absorber included in the PSA layer, one, two or more species can be suitably selected and used among the laser absorbers exemplified earlier. The laser absorber content in the PSA layer is usually suitably 5% by weight or less of the PSA layer: from the standpoint of the adhesive properties, it is preferably 3% by weight or less, or even 1% by weight or less. The art disclosed herein can be preferably implemented in an embodiment where the PSA layer is essentially free of a laser absorber.

### (Other Additives)

Besides the components described above, the PSA composition may comprise, as necessary various additives generally known in the field of PSA, such as tackifier (tackifier resin), leveling agent, defoaming agent crosslinking accelerator, plasticizer, filler, colorant such as pigment and dye, softener, anti-static agent, anti-aging agent, UV absorber, antioxidant and photo-stabilizer. With respect to these various additives, heretofore known species can be used by typical methods. In a PSA sheet for a purpose that unwelcomes siloxane gas (e.g. a PSA sheet applied to the interior of a magnetic disc device or to an area in contact with the interior), it is desirable to avoid the use of a silicone-based additive (e.g. silicone-based leveling agent and defoaming agent).

In the art disclosed herein, the amount of outgassing from the PSA sheet is limited to or below a certain value. Thus, it is desirable to avoid the use of a low molecular weight component that may lead to outgassing. From such a standpoint, the other additive content (e.g, tackifier resin, anti-aging agent, UV absorber, antioxidant, photo-stabilizer) in the PSA layer is preferably limited to below about 30% (preferably below 10%, typically below 3%. e.g. below 1%) by weight. The art disclosed herein can be preferably implemented in an embodiment where the PSA layer is essentially free of a tackifier resin. The art disclosed herein can also be preferably implemented in an embodiment where the PSA layer is essentially free of UV absorber, antioxidant, and photo-stabilizer such as hindered amine-based photo-stabilizer and hindered phenolic antioxidant.

The PSA layer can be formed based on a method for forming a PSA layer in a known PSA sheet. For example, it is preferable to use a method (direct method) where a PSA composition having PSA-layer-forming materials dissolved or dispersed in a suitable solvent is directly provided (typically applied) to a substrate and allowed to dry to form a PSA layer. In another method (transfer method) that can be employed, the PSA composition is provided to a highly-releasable surface (e.g. a surface of a release liner, a substrate's backside that has been treated with release agent, etc.) and allowed to dry to form a PSA layer on the surface, and the PSA layer is transferred to a substrate. As the release face, a release liner surface, a substrate's backside that is highly releasable, and the like can be used. From the standpoint of reducing the amount of silicone in adhesive face, the amount of silicone in release face is preferably at or below a certain level (e.g. at or below 20 ng/cm²) like the release liner forming the release-lined PSA sheet described later.

The form of the PSA composition is not particularly limited. For instance, it can be in various forms, such as a PSA composition (a solvent-based PSA composition) that comprises PSA-layer-forming materials as described above in an organic solvent, a PSA composition (water-dispersed PSA composition, typically an aqueous emulsion-based PSA composition) in which the PSA is dispersed in an aqueous solvent, a PSA composition that is curable by an active energy ray (e.g. UV ray), and a hot-melt PSA composition. From the standpoint of the ease of application and the adhesive properties, a solvent-based PSA composition can be preferably used. As the solvent, it is possible to use one species of solvent or a mixture of two or more species, selected among aromatic compounds (typically aromatic hydrocarbons) such as toluene and xylene; acetic acid esters such as ethyl acetate and butyl acetate; and aliphatic or alicyclic hydrocarbons such as hexane, cyclohexane, heptane and methyl cyclohexane. While no particular limitations are imposed, it is usually suitable to adjust the solvent-based PSA composition to include 5% to 45% non-volatiles (NV) by weight. Too low an NV tends to result in higher production costs while too high an NV may degrade the handling properties such as the ease of application. It can be advantageous to adjust the NV of the solvent-based PSA composition to or below a certain level (preferably to or below 35% by weight, more preferably to or below 30% by weight, e.g, to or below 28% by weight) also in view of facilitating removal of other possible volatiles included besides the solvent by volatilization along with the solvent while the composition is allowed to dry and reducing the amount of thermally released gas of the PSA layer.

The PSA composition can be applied, for instance, with a known or commonly used coater such as gravure roll coater, reverse roll coater, kiss roll coater, dip roll coater, bar coater, knife coater and spray coater.

In the art disclosed herein, the thickness of the PSA layer forming the adhesive face is not particularly limited. The PSA layer usually has a thickness of suitably 3 μm or greater, preferably 10 μm or greater, or more preferably 20 μm or greater. With increasing thickness of the PSA layer, the adhesive strength to adherend tends to increase. Having at least a certain thickness, the PSA layer absorbs the adherend's surface roughness to form tight adhesion. When the PSA layer has a thickness of 10 μm or greater, for instance, it can provide good, tight adhesion to an adherend having a surface whose arithmetic mean surface roughness Ra is about 1 μm to 5 μm (e.g. 3 μm). The thickness of the PSA layer forming the adhesive face can be, for instance, 150 μm or less; it is suitably 100 μm or less, or preferably 70 μm or less. By decreasing the thickness of the PSA layer, the amount of outgassing from the PSA layer can be reduced. A smaller thickness of the PSA layer is also advantageous from the standpoint of reducing the thickness and weight of the PSA sheet. In some embodiments, the thickness of the PSA layer can be, for instance, 50 μm or less, 35 μm or less, or even 30 μm or less.

### (Properties of PSA Layer)

The storage modulus at 25° C., G′(25° C.), of the PSA layer disclosed herein is not, particularly limited and it can be set in a suitable range according to required properties, etc. In a preferable embodiment, the G′(25° C.) is less than 0.5 MPa. Hereinafter, the storage modulus G′ at 25° C. may be indicated as G′(25° C.). The PSA layer with G′(25° C.) at or below a prescribed value wets the adherend surface well to form tight adhesion. The G′(25° C.) is more preferably 0.4 MPa or less, yet more preferably 0.3 MPa or less, or particularly preferably 0.25 MPa or less. The G′(25° C.) can also be, for instance, 0.2 MPa or less. The minimum G′(25° C.) value is not particularly limited and is usually suitably greater than about 0.01 MPa. From the standpoint of the adhesive properties and of preventing leftover adhesive residue, etc., it is preferably 0.05 MPa or greater, or more preferably 0.07 MPa or greater (e.g. 0.1 MPa or greater).

In the art disclosed herein, the storage moduli G′(25° C.) of a PSA layer can be determined by dynamic elastic modulus measurement. In particular, several layers of the PSA subject to measurement are layered to fabricate an approximately 2 mm thick PSA layer. A specimen obtained by punching out a disc of 7.9 mm diameter from the PSA layer is fixed between parallel plates. With a rheometer (e.g. ARES available from TA Instruments or a comparable system), dynamic elastic modulus measurement is carried out to determine the storage moduli G′(25° C.). The PSA (layer) subject to measurement can be formed by applying a layer the corresponding PSA composition on a release face of a release liner or the like and allowing it to dry or cure. The thickness (coating thickness) of the PSA layer subjected to the measurement is not particularly limited as long as it is 2 mm or less. It can be, for instance, about 50 μm.
Measurement mode: shear mode
Temperature range: −50° C., to 150° C.
Heating rate: 5° C./min
Measurement frequency: 1 Hz

While no particular limitations are imposed, the PSA layer in the art disclosed herein has a storage modulus G′ of 50 kPa or greater at 120° C. Hereinafter, the storage modulus G′ at 120° C. may be called the high-temperature elastic modulus. For instance, when the PSA layer has a high high-temperature elastic modulus, it can resist the contraction stress of the substrate that is about to shrink by the heat of laser machining, thereby better maintaining the bonding between the PSA sheet and the adherend. From such a standpoint, the high-temperature elastic modulus of the PSA layer can be, for instance, 60 kPa or greater, or even 70 kPa or greater. The high-temperature elastic modulus is usually suitably about 150 kPa or less, less than 120 kPa, less than 100 kPa, or even less than 90 kPa.

While no particular limitations are imposed, the gel fraction of the PSA layer in the art disclosed herein is preferably in a range of 20% to 99% by weight, or more preferably in a range of 30% to 95%. When the gel fraction is in these ranges, tight adhesion to adherend is likely to be combined with suitable cohesion. In some embodiments, the gel fraction of the PSA layer (e.g. a PSA layer comprising an acrylic polymer as the base polymer) can be, for instance, above 40%, above 50%, above 60%, above 65%, or even 75% or higher. The gel fraction of the PSA layer can be increased to reduce the amount of outgassing. Alternatively, from the standpoint of tight adhesion, in some embodiments, the gel fraction can be, for instance, 90% or lower, 80% or lower or even 70% or lower. The gel fraction is determined by the method described below. The same measurement method is also used in the working examples described later.

### [Determination of Gel Fraction]

A PSA sample (weight: Wg₁) weighing approximately 0.1 g is wrapped into a pouch with a porous polytetrafluoroethylene membrane (weight: Wg₂) having an average pore diameter of 0.2 μm, and the opening is tied with twine (weight: Wg₃). As the porous polytetrafluoroethylene membrane, trade name NITOFLON® NTF1122 (available from Nitto Denko Corporation, 0.2 μm average pore diameter, 75% porosity 85 μm thick) or an equivalent product is used. The pouch is immersed in 50 mL of ethyl acetate and stored at room temperature (typically 23° C.) for 7 days to extract the sol (ethyl acetate-soluble portion) in the PSA out of the membrane. Subsequently the pouch is collected, and any residual ethyl acetate is wiped off the outer surface. The pouch is dried at 130° C. for 2 hours and the pouch's weight (Wg₄) is measured. The PSA's gel fraction G_{C} is determined by substituting the respective values into the following equation:

Gel Fraction G_{C}(%)=[(Wg₄−Wg₂−Wg₃)/Wg₁]×100

### <Release Liner>

In the art disclosed herein, a release liner can be used during formation of the PSA layer; fabrication of the PSA sheet; storage, distribution and shape machining of the PSA sheet prior to use, etc. The release liner is not particularly limited. For example, it is possible to use a release liner having a release layer on the surface of a liner substrate such as resin film and paper: a release liner formed from a low adhesive material such as a fluoropolymer (polytetrafluoroethylene, polychlorotrifluoroethylene, polyvinyl fluoride, polyvinylidene fluoride, tetrafluoroethylene-hexafluoropropylene copolymer chlorofluoroethylene-vinylidene fluoride copolymer, etc.) or a polyolefinic resin (PE. PP, etc.); or the like. The release layer can be formed, for instance, by subjecting the liner substrate to a surface treatment with a release agent such as a silicone-based, long-chain alkyl-based, fluorine-based, or molybdenum disulfide-based release agent. When the PSA sheet disclosed herein is applied to a magnetic disc device (e.g, to the interior of the magnetic disc device, or to an area facing the interior), it is particularly preferable to use a non-silicone-based release liner free of a silicone-based release agent which may produce siloxane gas. A particularly preferable release liner is a polyolefinic release liner that is monolayered or multilayered with two or more layers, having a polyolefinic resin layer forming the PSA layer-facing side. A polyethylene-based release liner in which the layer forming the PSA layer-facing side is formed of polyethylene is particularly preferable. In the polyolefinic release liner, at least the layer forming the PSA layer-facing side should be formed of a polyolefinic resin: it can be, for instance, a laminate film of a polyolefinic resin and a non-polyolefinic resin.

An example of the release liner (e.g, the release liner used as a component of the release-lined PSA sheet) that can be preferably used in the art disclosed herein is a laminate film that has a PSA layer-facing side constituted with a release layer (C) formed of a polyolefinic resin as well as a base film (A) on the release layer's backside (on the reverse side of the PSA layer-facing side).

As the material of the release layer (C) constituting the laminate film, a polyethylenic resin is preferable: in particular, a polyethylenic resin comprising a linear low-density polyethylene as the primary component (i.e. a component accounting for at least 50% by weight) is preferable. For instance, a preferable release layer (C) is formed of a polyethylene resin that comprises a linear low-density polyethylene as the primary component and includes approximately 1% to 25% (e.g. 5% to 25%) low-density polyethylene by weight. From the standpoint of the ease of forming the release layer (C), etc., a polyethylene resin having a melt flow rate of 4 g/10 min to 15 g/10 min (based on JIS K6760) can be favorably used.

As the base film (A), for instance, polyester-based resin film such as PET film and PBT film as well as polypropylene resin film can be used. From the standpoint of the strength and handling properties. PET film is particularly preferable. For instance, the surface of the base film (A) can be subjected to a surface treatment to enhance the tightness of adhesion to the adjacent layer.

In the laminate film, the base film (A) and the release layer (C) may be layered with a middle layer (B) placed between them. In a favorable example, the middle layer (B) can be formed of a low-density polyethylene. From the standpoint of the ease of forming the middle layer (B), in general, a low-density polyethylene commercially available in laminate-forming grade can be favorably used. In particular, a low-density polyethylene having a melt flow rate in the range of 4 g/10 min to 15 g/10 min (based on JIS K6760) can be favorably used.

It is noted that each of the base film (A), middle layer (B) and release layer (C) can have a monolayer structure or a multilayer structure with two or more layers. These layers may include small amounts of other components (e.g. resins and additives) as necessary:

The thickness of the base film (A) is not particularly limited: it can be selected from a range of for instance, 10 μm or greater and 150 μm or less. In some embodiments, the base film (A) may have a thickness of, for instance, 20 μm or greater, 30 μm or greater, or even 40 μm or greater. The base film (A) having at least a prescribed thickness facilitates half cutting of the PSA sheet on the release liner (laminate film). This can be advantageous from the standpoint of refining the PSA sheet. The thickness of the base film (A) can be, for instance, 100 μm or less, 80 μm or less, or even 60 am or less. When the base film (A) (e.g. PET film) is not too thick or too thin, the work of picking up the PSA sheet from the release liner that includes the base film (A) tends to be facilitated.

The thickness of the release layer (C) is not particularly limited. From the standpoint of the ease of manufacturing and quality stability of the laminate film, the release layer (C) may have a thickness of, for instance, about 5 μm or greater, or even about 7 μm or greater. From the standpoint of reducing the total thickness of the release liner, the thickness of the release layer (C) can be, for instance, about 20 μm or less, or even about 15 μm or less.

In an embodiment having a middle layer (B), the thickness of the middle layer (B) is not particularly limited. From the standpoint of the ease of forming the middle layer (B), the middle layer (B) may have a thickness of, for instance, about 5 μm or greater, or even about 7 μm or greater. From the standpoint of reducing the total thickness of the release liner, the thickness of the middle layer (B) can be, for instance, about 20 μm or less, or even about 15 μm or less.

Between the base film (A) and the middle layer (B), a primer layer may be formed as necessary to tighten their bonding. The primer used for forming the primer layer can be selected in view of the ability to tighten the bonding and the application of the PSA sheet. In a release liner used in a PSA sheet applied to magnetic disc devices and other electronic devices, examples of the primer that can be favorably used include a primer (anchor coat) obtained by dissolving an ester-urethane-based adhesive or an ether-urethane-based adhesive in a suitable solvent (e.g. organic solvents including acetic acid esters such as ethyl acetate and ketones such as methyl ethyl ketone and acetone). It is noted that in a release liner for use in a PSA sheet used in the interior of a magnetic disc device or in an area facing the interior, it is preferable to avoid the use of a primer that comprises an ethylene-imine-based compound or a silane coupling agent. The primer layer may have a thickness of, for instance, 0.05 μm to 1.5 μm, 0.05 am to 0.5 μm, or even 0.05 μm to 0.2 μm. From the standpoint of reducing outgassing, it may be advantageous to minimize the primer layer's thickness while keeping the thickness at a level required for desirable bond-tightening effect.

The total thickness of the release liner is not particularly limited; it can be, for instance, 20 m or greater, 40 μm or greater, or even 60 μm or greater. The release liner having at least a certain thickness facilitates half cutting of the PSA sheet on the release liner (laminate film). In some embodiments, the release liner may have a total thickness of, for instance, 180 μm or less, 150 μm or less, 120 μm or less, or even 100 μm or less. From the standpoint of reducing the total thickness of the release-lined PSA sheet, it is preferable that the release liner is not excessively thick. It may be advantageous that the release liner is not too thick or too thin from the standpoint of the ease of picking up the PSA sheet from the release liner.

### <Applications>

The PSA sheet disclosed herein exhibits a good laser absorbance; and therefore, it has excellent machinability by laser irradiation (laser machinability). Thus, the PSA sheet can be preferably used in an embodiment that involves laser machining. Examples of the laser machining that may be provided to the PSA sheet include cutting the PSA sheet along a prescribed outline, forming a notch in the PSA sheet, and forming a through hole in the PSA sheet: however, it is not limited to these. Laser machining can be provided to the PSA sheet before, after, or both before and after the PSA sheet is adhered to an adherend. From the standpoint of benefiting from the machinability by laser irradiation, the PSA sheet disclosed herein can be preferably used in an embodiment where it is subjected to laser machining after adhered to an adherend.

The PSA sheet disclosed herein is suited for use in electronic devices because it has good laser machinability while the gas release is reduced. For instance, in manufacturing of magnetic disc devices and other electronic devices, it can be used for fastening and bonding a component forming the electronic devices. Here, the “fastening” of a component with the PSA sheet refers to using the PSA sheet to guide or control one, two or more of the position, shape and orientation of the component. For instance, the fastening can prevent, inhibit or control the component's migration, deformation, inclination, rotation, etc. After such fastening of a component with the PSA sheet the component can be more firmly fixed by other fastening means (e.g. addition of adhesive, welding, screwing, etc.) instead of the PSA sheet. Non-limiting examples of preferable applications of the PSA sheet disclosed herein include an embodiment using the PSA sheet for positioning or guiding a component. In an embodiment, the component can be preferably positioned or guided by using the shape of a through hole, notch and the like formed (possibly by laser machining) in the PSA sheet adhered on an adherend, for instance, by engaging the component in these shapes. The PSA sheet disclosed herein is preferably nonconductive. With such a PSA sheet, the component can be fastened and insulated at once.

FIG. 4 shows an embodiment of the magnetic disc device as a favorable example to which the art disclosed herein can be applied. FIG. 4 shows a perspective diagram schematically illustrating the general structure of the magnetic disc device according to an embodiment. A magnetic disc device 100 comprises a data-recording magnetic disc 110, a spindle motor 112 that rotates magnetic disc 110, a magnetic head 114 that reads and writes data on magnetic disc 110, and an actuator 116 that supplies power to magnetic head 114. Actuator 116 has a built-in linear motor not shown in the drawing. The number of magnetic discs 110 can be one, two, three or more.

Components of magnetic disc device 100 are placed inside a housing 120 which should be thought as the casing of magnetic disc device 100. PSA sheet 1 disclosed herein is placed inside housing 120 or in an area in contact with its inner space. In typical, PSA sheet 1 is adhered onto one, two or more components (adherends) constituting magnetic disc device 100 and is used in this state inside housing 120, possibly for fastening (e.g. positioning, guiding, etc) these components or other components. The adherend to which PSA sheet 1 is adhered can be, for instance, the inner surface of housing 120. With PSA sheet 1, outgassing is limited and the release of silicone gas is preferably limited as well; and therefore, it is less likely to cause a malfunction and the like even when used inside a housing of a magnetic disc device as in this example.

PSA sheet 1 can be preferably used in an embodiment where it is adhered to the inner surface of housing (adherend) 120 to cover a through hole and/or a depression formed in the inner surface of housing 120, through holes are formed by laser machining in the areas where PSA sheet 1 does not make contact with housing 120, and a magnetic disc device component not shown in the drawing is installed by using the through holes. For instance, as shown in FIG. 5, after PSA sheet 1 is adhered to an area having a through hole 120A formed in housing 120, laser beam LB is irradiated to where PSA sheet 1 covers the opening of through hole 120A (i.e, the area not touching the surface of housing 120), thereby causing PSA sheet 1 to decompose and disappear in that particular area. By this, a through hole in a size generally corresponding to the irradiation width of the laser beam LB can be preferably formed with good shape accuracy and position accuracy. For instance, the art disclosed herein can be implemented in an embodiment where the laser machining width (width W shown in FIG. 5: in case of an eyelet hole, the width W corresponds to the diameter of the eyelet hole) is about 2 mm or less, preferably about 1 mm or less, or more preferably about 500 μm or less.

The laser light used for the machining is not particularly limited as long as it can precisely process the PSA sheet disclosed herein. For instance, the following can be used: YAG laser and YVO laser having a dominant wavelength of roughly about 1064 nm, fiber laser having a dominant wavelength of mostly about 1050 nm, diode laser having a dominant wavelength of roughly about 950 nm, carbon dioxide laser having a dominant wavelength of roughly about 10 μm, and the like. From the standpoint of the precision and speed of machining, short-wavelength laser light can be preferably used. For instance, preferable laser light has a dominant wavelength in a range of roughly 900 nm to 1100 nm.

Matters disclosed by this description include the following:

(1) A PSA sheet for use in an electronic device, the PSA sheet comprising a substrate and a PSA layer provided to at least one face of the substrate,

having a laser absorbance of 20% or higher in a wavelength range of 1000 nm to 1100 nm,

having a thermal shrinkage S_{MD} in its machine direction and a thermal shrinkage S_{TD} in its transverse direction (direction perpendicular to the machine direction) of both −2% or greater and 2% or less, and having an amount of thermally released gas of 1300 ng/cm² or less when determined at 80° C. for 3 hours by gas chromatography/mass spectrometry (2) The PSA sheet according to (1) above, having a peel distance less than 50 mm in a constant load peel test where a 30 g load is applied for one hour.

(3) The PSA sheet according to (1) or (2) above, wherein the substrate has a thickness of 30 μm or greater.
(4) The PSA sheet according to any of (1) to (3) above, wherein the substrate comprises a resin film having a laser absorber.
(5) The PSA sheet according to (4) above, wherein the resin film has a monolayer structure.
(6) The PSA sheet according to (4) or (5) above, wherein the laser absorber comprises carbon black.
(7) The PSA sheet according to any of (1) to (6) above, having an amount of silicone of 20 ng/cm² or less based on polydimethylsiloxane standards and its X-ray intensity of silicon obtained by X-ray fluorescence analysis of the PSA layer surface.
(8) The PSA sheet according to any of (1) to (7) above, wherein the PSA layer is an acrylic PSA layer comprising an acrylic polymer as a base polymer.
(9) The PSA sheet according to any of (1) to (7) above, wherein the PSA layer is a rubber based PSA layer comprising a rubber-based polymer as a base polymer.
(10) The PSA sheet according to (9) above, wherein at least one species selected from the group consisting of butene, isobutylene and isoprene is polymerized in the rubber-based polymer.
(11) The PSA sheet according to (9) or (10) above, wherein the rubber-based PSA layer comprises a rubber-based polymer A and a rubber-based polymer B, wherein at least 50% (by weight) isobutylene is polymerized in the rubber-based polymer A, and

isobutylene and isoprene are copolymerized in the rubber-based polymer B.

(12) The PSA sheet according to any of (1) to (11) above, wherein the PSA layer has a thickness of 3 μm or greater and 150 μm or less.
(13) The PSA sheet according to any of (1) to (12) above, wherein the substrate has a thickness (μm) equivalent to at least 30%, preferably at least 45%, more preferably more than 50%, or yet more preferably more than 60% of the total thickness (μm) of the PSA sheet.
(14) The PSA sheet according to any of (1) to (12) above, having a form of single-faced PSA sheet that has the PSA layer only on one face of the substrate.
(15) The PSA sheet according to any of (1) to (14) above, having a tensile modulus per unit width greater than 800 N/cm and less than 3500 N/cm.
(16) The PSA sheet according to any of (1) to (15) above, wherein the laser absorbance is 60%6 or greater.
(17) A release-lined PSA sheet comprising the PSA sheet according to any of (1) to (16) above and a release liner placed in contact with the PSA layer, wherein the release liner has an amount of silicone of 20 ng/cm² or less based on polydimethylsiloxane standards and its X-ray intensity of silicon obtained by X-ray fluorescence analysis of its PSA layer-side surface.
(18) A release-lined PSA sheet comprising the PSA sheet according to any of (1) to (16) above and a release liner placed in contact with the PSA layer, wherein the release liner is a non-silicone-based release liner free of a silicone-based release agent.
(19) The release-lined PSA sheet according to (17) or (18) above, wherein the release liner comprises a release layer constituting its PSA layer-facing side and a base film placed on its release layers backside, wherein

the release layer comprises a linear low-density polyethylene as its primary component, and

the base film is selected between a polyester-based resin film and a polypropylene resin film.

(20) The release-lined PSA sheet according to (19) above, wherein the base film and the release layer are layered with a middle layer placed between them and the middle layer is formed of a low-density polyethylene.
(21) The release-lined PSA sheet according to any of (17) to (20), wherein the release liner has a total thickness of 20 μm or greater and 180 μm or less.
(22) An electronic device comprising the PSA sheet according to any of (1) to (16) above.
(23) The electronic device according to (22) above, wherein the PSA sheet has a through hole formed by laser machining.
(24) The electronic device according to (23) above, having a component installed through the through hole.
(25) The electronic device according to any of (22) to (24) above, wherein the electronic device is a magnetic disc device.
(26) A method for producing an electronic device, the method comprising

applying the PSA sheet according to any of (1) to (16) above to a component of an electronic device, and

subjecting the PSA sheet to laser machining.

(27) The electronic device production method according to (26) above, wherein the laser machining is provided to an area where the PSA sheet applied to the component is not in contact with the component.
(28) The electronic device production method according to (26) or (27) above, wherein the laser machining forms a through hole or a notch in the PSA sheet.
(29) The electronic device production method according to any of (26) to (28) above, wherein after the laser machining, another component of the magnetic disc device is installed by engaging it in the through hole or the notch.
(30) The electronic device production method according to any of (26) to (29) above, wherein the electronic device is a magnetic disc device.

### Examples

Several working examples related to the present invention are described below, but, the present invention is not, intended to be limited to these examples. In the description below. “parts” and “%” are by weight unless otherwise specified.

### <Materials Used>

### [Acrylic Polymers]

### (Preparation of Acrylic Polymer A)

Using 93 parts of n-butyl acrylate (BA), 7 parts of acrylic acid (AA) and 0.05 part of 4-hydroxybutyl acrylate (4HBA): ethyl acetate as the polymerization solvent: and 0.1 part of 2,2′-azobisisobutylonitrile (AIBN) as the azo-based polymerization initiator: solution polymerization was carried out by a typical method to obtain a solution (25% NV) of acrylic polymer A having a weight average molecular weight (Mw) of 125×10⁴.

### (Preparation of Acrylic Polymer B)

A larger amount of AIBN was used. Otherwise in the same manner as the preparation of acrylic polymer A, was obtained a solution (25% NV) of acrylic polymer B having a Mw of 40×10⁴.

### [Rubber-Based Polymers]

PIB: polyisobutylene available from BASF Corporation, product name OPPANOL N50 Mw≈34×10⁴, Mw/Mn=5.0

IIR: butyl rubber available from JSR, product name JSR BUTYL 268, Mw ˜54×10⁴. Mw/Mn ˜4.5

PB: polybutene available from JXTC Nippon Oil & Energy Corporation, product name NISSEKI POLYBUTENE HV-1900, Mn 2900

### [Substrate]

Substrate A: 50 μm thick black-colored PET film (LUMIRROR X30 available from Tray Industries, Inc.)

Substrate B: 38 μm thick black-colored PET film (LUMIRROR X30 available from Tray Industries, Inc.)

Substrate C: 100 μm thick black-colored PET film (LUMIRROR X30 available from Toray Industries, Inc.)

Substrate D: 50 μm thick white-colored PET film (DIAFOIL W400 available from Mitsubishi Plastics, Inc.)

Substrate E: 50 μm thick transparent PET film (LUMIRROR S10 available from Toray Industries, Inc.)

Substrate F: 50 μm thick white-colored polyethylene film having a corona discharge-treated face, formed by inflation molding of a resin material containing 5% titanium oxide and 95% low density polyethylene (PETROTHENE 186R available from Tosch Corporation) followed by corona discharge treatment on one face (the face on which the PSA layer was formed)

### [Release Liners]

Release liner A: To 100 parts of an ester-urethane-based anchor coat (trade name AD-527 available from Toyo-Morton, Ltd.), was added 7 parts of a curing aid (trade name CAT HY-91 available from Toyo-Morton. Ltd.). To this, was added ethyl acetate to 5% NV (non-volatiles) to prepare an anchor coat (primer) solution. The anchor coat solution was applied with a roll coater to 50 μm thick PET film (LUMIRROR S-105-50 available from Toray Corporation; base film (A)) and allowed to dry at 80° C., to form a 0.1 μm thick anchor coat layer. On the anchor coat layer, a low-density polyethylene (L-1850A available from Asahi Kasei Suntec) was laminated to a thickness of 10 μm by extrusion in tandem mode at an under-die temperature of 325° C., to form a middle layer (B). Subsequently, onto the middle layer (B), a release layer-forming resin composition was laminated to a thickness of 10 μm by extrusion at an under-die temperature of 273° C., to form a release layer (C) and thereby to obtain an approximately 70 μm thick silicone-free release liner A. As the release layer-forming resin composition, was used a mixture of 100 parts of a resin mixture comprising a linear low-density polyethylene as the primary component (MORETEC 0628D available from Idemitsu Petrochemical Co., a resin mixture containing 15% low-density polyethylene in linear low-density polyethylene) and 10 parts of an ethylene-propylene copolymer (TAFMER P0180 available from Mitsui Chemicals, Inc.).

Release liner B: Was used a commercial release liner (DIAFOIL MRE available from Mitsubishi Plastics. Inc.) having a release face formed of a silicone-based release agent on one face of 50 μm thick polyester film.

### <Preparation of PSA Sheets>

### Example 1

To the acrylic polymer A solution, were added 2 parts (based on solid content) of isocyanate-based crosslinking agent (product name CORONATE L, 75% ethyl acetate solution of trimethylol propane/tolylene diisocyanate trimer adduct, available from Tbsoh Corporation) to 100 parts of acrylic polymer A in the solution to prepare an acrylic PSA composition (Acryl A). The Acryl A was applied to one face of substrate A and allowed to dry to form a 25 m thick PSA layer. To the surface of the PSA layer, was adhered the release face of release liner A. A PSA sheet (release-lined PSA sheet) according to Example 1 was thus obtained, with the adhesive face protected with release liner A. The PSA layer according to this example had a gel fraction of 65% and a high-temperature elastic modulus of 80 kPa.

### Examples 2 to 6

In place of substrate A, were used the substrates shown in Table 1, respectively. Otherwise in the same manner as Example 1, were obtained release-lined PSA sheets according to the respective Examples.

### Examples 7 and 8

The coating amount of Acryl A was adjusted to form PSA layers having the thicknesses shown in Table 1. Otherwise in the same manner as Example 1, were obtained release-lined PSA sheets according to the respective Examples.

### Example 9

To the acrylic polymer B solution, were added 2 parts (based on solid content) of isocyanate-based crosslinking agent (product name CORONATE L, 75% ethyl acetate solution of trimethylol propane/tolylene diisocyanate trimer adduct, available from Tosoh Corporation) to 100 parts of acrylic polymer B in the solution to prepare an acrylic PSA composition (Acryl B). Using Acryl B in place of Acryl A, but otherwise in the same manner as the preparation of PSA sheet according to Example 1, was obtained a PSA sheet according to this Example.

### Example 10

In toluene, were dissolved PIB and IIR at a 1:1 weight ratio to prepare a PSA composition with 25% NV Using this PSA composition in place of Aryl A, but otherwise in the same manner as Example 1, was obtained a release-lined PSA sheet according to this Example.

### Example 11

In toluene, were dissolved IIR and PB at a 1:1 weight ratio to prepare a PSA composition with 25% NV Using this PSA composition in place of Acryl A, but otherwise in the same manner as Example 1, was obtained a release-lined PSA sheet according to this Example.

### Example 12

To the adhesive face, was adhered release liner B in place of release liner A. Otherwise in the same manner as Example 1, was obtained a release-lined PSA sheet according to this Example.

### <Evaluation of Properties>

The resulting release-lined PSA sheets were evaluated with respect to the following items.

### 1. Determination of Laser Absorbance

### (1) Transmittance

System: model name U-4100, spectrophotometer available from Hitachi High-Technologies Corporation

Conditions: Advanced detection mode, % T data mode, scanning speed 750 nm/min, sampling interval 1 nm, automated slit control, automated photomultiplier voltage 1, light quantity control fixed, high resolution detection OFF extinction plate unused, PbS sensitivity 1, 10 mm cell length

Method:

(i) The system was turned on and warmed up for at least 2 hours to stabilize the system. The baseline was then obtained without a sample.

(ii) A sample was then set in the system's transmittance-measuring cite so that the light enters the PSA sheet from its back and the transmittance in the wavelength range of 1000 nm to 1100 nm was determined under the conditions shown above.

### (2) Reflectance

System: model name U-4100, spectrophotometer available from Hitachi High-Technologies Corporation

Conditions: Advanced detection mode, % R data mode, scanning speed 750 nm/min, sampling interval 1 nm, automated slit control, automated photomultiplier voltage 1, light quantity control fixed, high resolution detection OFF extinction plate unused, PbS sensitivity 1, 10 mm cell length

Method:

(i) The system was turned on and warmed up for at least, 2 hours to stabilize the system. A standard white plate was then set in the reflectance-measuring cite and the baseline was obtained without a sample.

(ii) A sample was then set in the reflectance-measuring cite. For this, to prevent reflection of the light that has transmitted through the sample, the PSA sheet sample was adhered to a 1 mm thick black resin plate (trade name CLAREX® available from Nitto Jushi Kogyo Co., Ltd.) with a 2 kg roller moved back and forth once, with the resin plate placed on the reverse side of the sample's light-entering side. The reflectance in the wavelength range of 1000 nm to 1100 nm was determined under the conditions shown above.

### (3) Absorbance

From the transmittance T (%) and reflectance R (%), by the next equation, laser absorbance (%)=100(%)−T (%)−R (%), was determined the minimum absorbance in the wavelength range of 1000 nm to 1100 nm. In Tables 1 and 2, based on the resulting value, the laser absorbance is shown in the following three grades:

E: laser absorbance at or above 60% (excellent laser absorption)

G: laser absorbance at or above 20% and below 60% (good laser absorption)

P: laser absorbance below 20% (poor laser absorption)

### 2. Shape Stability Test

Using a press with a Thomson blade, the release-lined PSA sheet according to each Example was half-cut to a depth below the release liner surface from the PSA sheet's backside through the PSA sheet. By this, on the release liner, a 100 mm long, 40 mm wide PSA piece for the shape stability test was cut off from the surrounding areas.

Two rectangular stainless steel plates (100 mm long, 100 mm wide, 0.4 mm thick) were obtained and placed 2 mm apart in parallel From the release liner constituting the release-lined PSA sheet according to each Example, the PSA piece was removed (picked up). The PSA piece was positioned so that its lengthwise centerline coincided with the lengthwise centerline of the 2 mm gap and was press-bonded to the stainless steel plates with a 2 kg roller moved back and forth once. This was left standing in an environment at 23° C., and 50% RH for 30 minutes. Of the PSA piece, the area across the gap was subjected to laser machining under the conditions shown below. The laser light was irradiated from the backside of the PSA piece.

Laser: YAG laser (wavelength 1064 nm, output 500 W)

Irradiation: moving speed 10 m/min

Cut pattern: 10 mm long, 0.3 mm wide slits formed 10 mm apart from each other along the lengthwise centerline of the space.

After the laser machining, with a 10 N stress applied in the direction to broaden the gap between the two stainless steel plates, the laser-machined area of the PSA piece was inspected with a 100× magnifier. Based on the observations, the shape stability was evaluated in the following three grades:

E: highly accurate shape (excellent shape stability)

G: slight deformation found, yet still satisfactory for practical use (good shape stability)

P: clear deformation found (poor shape stability)

By the aforementioned method, were determined the thermal shrinkage (%), the amount of thermally released gas (ng/cm²), the amount of silicone in adhesive face (surface silicone) (ng/cm²), and the peel distance (mm) according to the constant load peel test.

The results are shown in Tables 1 and 2. In Tables, the MD thermal shrinkage (S_{MD}) is shown for the thermal shrinkage. It is noted that the TD thermal shrinkages (S_{MD}) of the PSA sheets according to Examples 1 to 4 and 7 to 12 were all −0.2% or greater and less than 0%.

TABLE 1

| | | Ex. 1 | Ex. 2 | Ex. 3 | Ex. 4 | Ex. 5 | Ex. 6 |
|---|---|---|---|---|---|---|---|
| Substrate | Species | A | B | C | D | E | F |
| | Thickness(μm) | 50 | 38 | 100 | 50 | 50 | 50 |
| PSA | Species | Acryl A | Acryl A | Acryl A | Acryl A | Acryl A | Acryl A |
| | Thickness(μm) | 25 | 25 | 25 | 25 | 25 | 25 |

| | | | | | | |
|---|---|---|---|---|---|---|
| Release liner | A | A | A | A | A | A |
| Laser absorbance | E | E | E | G | P | G |
| Thermal shrinkage (%) | 0.1 | 0.1 | 0.1 | 0.1 | 0.3 | 3 |
| Shape stability | E | G | E | E | N.D. | P |
| Thermally released gas(ng/cm²) | 100 | 100 | 100 | 100 | 100 | 2000 |
| Surface silicone(ng/cm²) | 0 | 0 | 0 | 0 | 0 | 0 |
| Constant load peel (mm) | 2 | 2 | 2 | 2 | 2 | 40 |

N.D.: not determined

TABLE 2

| | | Ex. 7 | Ex. 8 | Ex. 9 | Ex. 10 | Ex. 11 | Ex. 12 |
|---|---|---|---|---|---|---|---|
| Substrate | Species | A | A | A | A | A | A |
| | Thickness(μm) | 50 | 50 | 50 | 50 | 50 | 50 |
| PSA | Species | Acryl A | Acryl A | Acryl B | PIB/IIR | IIR/PB | Acryl A |
| | Thickness(μm) | 10 | 50 | 25 | 25 | 25 | 25 |

| | | | | | | |
|---|---|---|---|---|---|---|
| Release liner | A | A | A | A | A | B |
| Laser absorbance | E | E | E | E | E | E |
| Thermal shrinkage (%) | 0.1 | 0.1 | 0.1 | 0.1 | 0.1 | 0.1 |
| Shape stability | E | E | E | E | E | E |
| Thermally released gas(ng/cm²) | 20 | 400 | 120 | 220 | 250 | 100 |
| Surface silicone(ng/cm²) | 0 | 0 | 0 | 0 | 0 | 25 |
| Constant load peel (mm) | 10 | 30 | 15 | 20 | 40 | 2 |

As shown in Tables 1 and 2, with respect to the PSA sheets according to Examples 1 to 4 and 7 to 12, taking advantage of their good laser absorbability laser machining was easily and suitably performed after they were applied to the adherend. The PSA sheets according to these Examples showed good size stability against heat as well as good shape stability; and therefore, they were found to be suited for fastening and installing a component. In addition, the PSA sheets of Examples 1 to 4, 7, 9 and 10 with relatively short peel distances in the constant load peel test showed highly reliable bonding to the adherend. With respect to the PSA sheets according to Examples 1 to 4 and 7 to 12, the amounts of thermally released gas were all as low as or lower than 1300 ng/cm². In the PSA sheets according to Examples 1 to 4 and 7 to 11 using the silicone-free release liner, the presence of silicone was not observed in the adhesive faces and they were found suitable for applications calling for their placement inside magnetic disc devices.

On the other hand, the PSA sheet of Example 5 with a low laser absorbance did not work for the laser machining in the shape stability test. The PSA sheet of Example 6 with a high thermal shrinkage exhibited low shape stability while adhered on the adherend with respect to the laser machining; it also released a large amount of gas when heated. The PSA sheet of Example 12 using the release liner B treated with a silicone-based release agent had a large amount of silicone in adhesive face and was not suitable for the internal use in magnetic disc devices.

It is noted that in the preparation of release liner A, the thickness of base film (A) was changed to 25 μm and 70 μm to fabricate two different silicone-free release liners B and C with total thicknesses of about 45 μm and about 90 μm: the same evaluation was carried out using these release liners in place of the release liner A (˜70 μm in total thickness) in Example 1; and similar to Example 1, the presence of silicone was not observed in the adhesive faces. When the release liner C (90 μm in total thickness) was used, in the shape stability test, the work of picking up the PSA piece was somewhat hindered as compared to when the release liner A was used. In addition, an acrylic polymer with Mw of 25×10⁴ was synthesized by increasing the amount of AIBN in the preparation of acrylic polymer B; using this acrylic polymer in place of acrylic polymer B, but otherwise in the same manner as Example 9, a PSA sheet was prepared; the resulting PSA sheet showed an increase in amount of thermally release gas as compared to Example 9, but it was still below 1000 ng/cm².

Although specific embodiments of the present invention have been described in detail above, these are merely for illustrations and do not limit the scope of claims. The art according to the claims includes various modifications and changes made to the specific embodiments illustrated above.

### REFERENCE SIGNS LIST

1, 2 PSA sheets
10 substrate
10A first face
10B second face (backside)
20 PSA layer
20A surface (adhesive face)
30 release liner
42 laser-absorbing layer
402 laser absorber
50 release-lined PSA sheet
100 magnetic disc device
110 magnetic disc
112 spindle motor
114 magnetic head
116 actuator
120 housing
120A through hole

What is claimed is:

1. A pressure-sensitive adhesive sheet for use in an electronic device, the pressure-sensitive adhesive sheet comprising a substrate and a pressure-sensitive adhesive layer provided to at least one face of the substrate,
having a laser absorbance of 20% or higher in a wavelength range of 1000 nm to 1100 nm,
having a thermal shrinkage S_{MD} in its machine direction and a thermal shrinkage S_{TD} in its transverse direction (direction perpendicular to the machine direction) of both −2% or greater and 2% or less, and
having an amount of thermally released gas of 1300 ng/cm² or less when determined at 80° C. for 3 hours by gas chromatography/mass spectrometry.

2. The pressure-sensitive adhesive sheet according to claim 1, having a peel distance less than 50 mm in a constant load peel test where a 30 g load is applied for one hour.

3. The pressure-sensitive adhesive sheet according to claim 1, wherein the substrate has a thickness of 30 μm or greater.

4. The pressure-sensitive adhesive sheet according to claim 1, wherein the substrate comprises a resin film having a laser absorber.

5. The pressure-sensitive adhesive sheet according to claim 4, wherein the laser absorber comprises a carbon black.

6. The pressure-sensitive adhesive sheet according to claim 1, having an amount of silicone of 20 ng/cm² or less based on polydimethylsiloxane standards and its X-ray intensity of silicon obtained by X-ray fluorescence analysis of the pressure-sensitive adhesive layer surface.

7. The pressure-sensitive adhesive sheet according to claim 1, wherein the pressure-sensitive adhesive layer is an acrylic pressure-sensitive adhesive layer comprising an acrylic polymer as a base polymer.

8. The pressure-sensitive adhesive sheet according to claim 1, wherein the pressure-sensitive adhesive layer is a rubber-based pressure-sensitive adhesive layer comprising a rubber-based polymer as a base polymer.

9. The pressure-sensitive adhesive sheet according to claim 8, wherein at least one species selected from the group consisting of butene, isobutylene and isoprene is polymerized in the rubber-based polymer.

10. The pressure-sensitive adhesive sheet according to claim 8, wherein the rubber based pressure-sensitive adhesive layer comprises a rubber-based polymer A and a rubber-based polymer B, wherein
at least 50% (by weight) isobutylene is polymerized in the rubber-based polymer A, and
isobutylene and isoprene are copolymerized in the rubber-based polymer B.

11. A release-lined pressure-sensitive adhesive sheet comprising the pressure-sensitive adhesive sheet according to claim 1 and a release liner placed in contact with the pressure-sensitive adhesive layer, wherein the release liner has an amount, of silicone of 20 ng/cm² or less based on polydimethylsiloxane standards and its X-ray intensity of silicon obtained by X-ray fluorescence analysis of its pressure-sensitive adhesive layer side surface.

12. A magnetic disc device comprising the pressure-sensitive adhesive sheet according to claim 1.

13. The magnetic disc device according to claim 12, wherein the pressure-sensitive adhesive sheet has a through hole formed by laser machining.
